(19) United States
(12) Patent Application Publication
(10) Pub. No.: US 2006/0223637 A1
(43) Pub. Date: Oct. 5, 2006

(54) VIDEO GAME SYSTEM COMBINING GAMING SIMULATION WITH REMOTE ROBOT CONTROL AND REMOTE ROBOT FEEDBACK

(75) Inventor: Louis B. Rosenberg, Pismo Beach, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: Outland Research, LLC, Pismo Beach, CA (US)

(21) Appl. No.: 11/278,120

(22) Filed: Mar. 30, 2006

Related U.S. Application Data
(60) Provisional application No. 60/666,805, filed on Mar. 31, 2005.

(51) Int. Cl. G06F 19/00

(52) U.S. Cl. 463/47

(57) ABSTRACT

An interactive apparatus is described comprising a portable gaming system and a mobile toy vehicle connected by a wireless communications link. The mobile toy vehicle has a drive system, a video camera, a communications link, a computer system, and vehicle control software. The gaming system comprises a visual display, a user interface, a communications link, a computer system and gaming software. The gaming system can display the real-time real-world images captured by the video camera mounted on the mobile toy vehicle overlaid with simulated gaming objects and events. In this way a combined on-screen off-screen gaming experience is provided for the user that merges real-world events with simulated gaming actions. The apparatus allows for single player and multiplayer configurations.

This application claims benefit under 35 U.S.C. § 119(e) to U.S. Provisional Application No. 60/666,805 filed Mar. 31, 2005.

### BACKGROUND OF THE INVENTION

1. Field of the Invention

The invention is in the field of personal gaming system 130 in general and personal gaming system 130 that interact with mobile robotic toy devices in particular.

2. Discussion of the Related Art

Gaming systems are popular way for people to entertain themselves and interact with other users. An example of a gaming system is the Sony PSP (Playstation Portable), is handheld, weighs approximately 1 lb, has a small screen to view images, has user control buttons, and a wireless interface. This device also communicates with other gaming system to allow for interactive playing between two or more individuals.

Mobile toys are also well known and a popular means of entertainment. Most mobile toys consist of a remote controller to operate the toy (e.g. move the toy forward, turn it right and left, etc.). The remote controller is typically connected with a wireless connection so that the operator may stand at one place and move the toy using a control panel.

Whether implemented on a personal computer, television-based gaming console, or handheld gaming system 130, traditional video games allow users to manipulate on-screen characters and thereby engage in on-screen challenges or competitions. While such on-screen challenges or competitions are fun and engaging for users, they often pull users away from the real physical world and cause them to sit mesmerized in a single location for hours at a time, fixated upon a glowing screen. This is very different from traditional toys that allow users to engage the world around them, incorporating their physical surroundings into their creative and physically active play activities. For example, a child playing with toy blocks or toy cars or toy planes will focus upon the toys but will also incorporate their physical surroundings into their play behavior, turning their room or their house or their yard into the field of play. This offers children a more diverse and creative experience than sitting in front of a screen and engaging simulated world. Computer generated challenges and competitions can be rich with stimulating content that is more dynamic and inspiring than an unchanging toy car or truck or plane. What is therefore needed is a novel means of combining the dynamically engaging benefits of computer generated content with the physically engaging benefits of traditional toys.

### SUMMARY

The preferred embodiment of an apparatus for user entertainment, said apparatus comprising: a plurality of mobile vehicles; a plurality of gaming systems; and a plurality of communication links between the mobile toy vehicles and the gaming systems.

The mobile toy vehicle further comprises: a; a weapons system; a vehicle location system; a video camera; a vehicle communications link interface; a power supply; a software configurable vehicle computer control system; wherein said software configurable vehicle computer control system operatively controls the drive system, the weapons system, the vehicle location system, the video camera, the vehicle communications link interface; and wherein the gaming system further comprises: a screen; a user interface; a software configurable gaming computer processor; wherein said software configurable gaming computer processor operatively controls the screen and user interface; wherein the mobile toy communications link interface sends data to the gaming system using the communications link interface.

Also provided is a method for controlling an apparatus that entertains, said method comprising: obtaining an image from mobile toy vehicle; transferring the image to a user game console; overlaying the image with a virtual object; displaying the overlaid image with the virtual object on the screen.

### BRIEF DESCRIPTION OF THE DRAWINGS

Preferred embodiments of the invention will be described in conjunction with the following drawings, in which:

FIG. 1 is a block diagram of the preferred embodiment of the gaming system; and

FIG. 2 is an example of the physical implementation of gaming system as depicted in FIG. 1; and

FIG. 3a is a block diagram of a two player system where each player has a gaming system and a mobile toy vehicle; and

FIG. 3b is a block diagram of a multiplayer system where each player has a gaming system and there is a single mobile toy vehicle; and

FIG. 4 is a block diagram of the gaming system with a simulated input module; and

FIG. 5 is a block diagram of the simulated input module; and

FIG. 6a is a picture of the screen of the gaming system where the display is unaltered; and

FIG. 6b is a picture of the screen of the gaming system where the display has been altered, in this case darkened, by the simulated inputs module; and

FIG. 6c is a flowchart showing the software process of altering the display by the simulated inputs module; and

FIG. 7 is a picture of a gaming system showing computer generated cracks; and the simulated inputs module; and

FIG. 8 is the screen display of the gaming system where the aiming system consisting of crosshairs is shown; and

FIG. 9 is the screen display of the gaming system where a simulated laser weapon has been fired at a bean bag chair in the real world; and

FIG. 10 is the screen display of the gaming system showing the virtual effects on the bean bag chair in the real world of the simulated laser beam; and

FIG. 11 is the screen display of the gaming system showing the placement of simulated images, in this instance a pyramid; and

FIG. 12 is the screen display of the gaming system showing the placement of simulated images, in this instance a barrier; and

FIG. 13 is the screen display of the gaming system showing a fuel meter and ammunition meter for the mobile toy vehicle being operated.

### DETAILED DESCRIPTION

While describing the invention and its embodiments various terms will be used for the sake of clarity. These terms are intended to not only include the recited embodiments, but also all equivalents that perform substantially the same function, in substantially the same manner to achieve the same result.

Mobile Toy and Gaming System

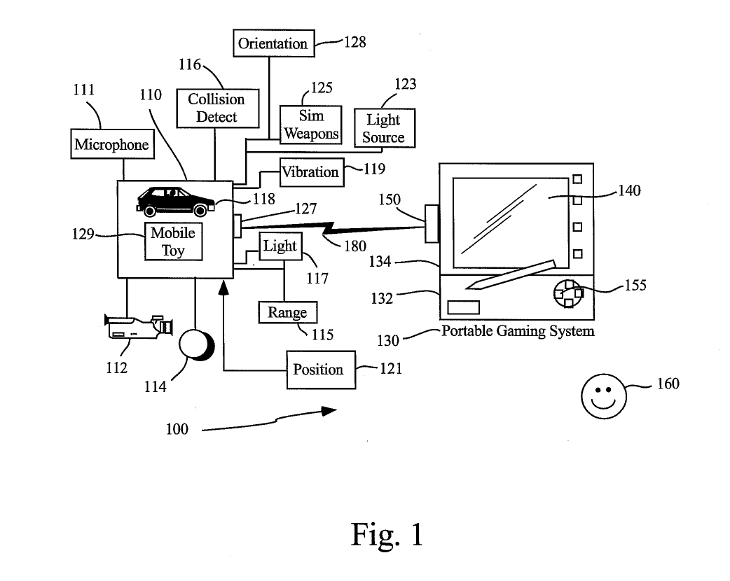

Now turning to FIG. 1, a block diagram of the preferred embodiment 100, is shown and described. The apparatus of the preferred embodiment includes a mobile toy vehicle 110 equipped with a wireless communications interface 180 connected to a portable gaming system 130. A user 160 interacts with the portable gaming system 130.

a. Mobile Toy Vehicle

The mobile toy vehicle 110 is equipped with some or all of the following; a microphone 111, a video camera 112, a drive system 114, a ranging system 115, a collision detection system 116, one or more light detectors 117 a vehicle computer 118, a vibration detection system 119, a position location system 121, one or more light sources 123, simulated weapons 125, an orientation sensor 218, and a vehicle communications interface 127. Vehicle computer software 120 is loaded into internal Read only Memory (ROM) and Random Access Memory (RAM) (both not shown).

The controlling device of the mobile toy vehicle 110 is the vehicle computer 118. The vehicle computer 118 is connected to the microphone 111 via an analog to digital converter (not shown). The vehicle computer 118 is connected to the video camera 112 either by an analog to digital converter (not shown) or by a digital interface. The drive system 114 is connected to the vehicle computer 118 using a digital to analog interface and drive circuitry. The ranging subsystem 115 is connected to the vehicle computer 118 using a digital or analog interface. The collision detection subsystem 116 is connected to the vehicle computer 118 using either an analog to digital or digital interface. The light sensor subsystem 117 is connected to the vehicle computer 118 using either a digital or analog interface. The vibration detection subsystem 119 is connected to the vehicle computer 118 using a digital or analog interface. The position location subsystem 121 is connected to the vehicle computer 118 using a digital or analog interface. The light source 123 is connected to the vehicle computer 118 using a digital or analog interface. The simulated weapons 125 are connected to the vehicle computer 118 using a digital or analog interface. A vehicle communications interface 127 supports the wireless interface 150 which connected to the portable gaming system 130. All of these interfaces are controlled and coordinated by a vehicle software 120.

The vehicle software 120 may be implemented using any number of popular computer languages, such as, C, Java, Perl, PHP, and assembly language. Executable code is loaded on the vehicle computer 118. The code may be modified during operation based on inputs and outputs from aforementioned interfaces.

Those skilled in the arts will appreciate that the individual subsystems of the mobile toy vehicle may be placed in different configurations without an appreciable change in functionality. Example embodiments of these configurations are further disclosed in this application.

The video camera 112 is affixed to its chassis such that the video camera 112 moves along with the mobile toy vehicle 110 and can capture video images in the forward direction of travel of the mobile toy vehicle 110. Alternately, the video camera may be mounted on a rotating platform to view in additional directions. Video data (not shown) from the video camera 112 affixed to the mobile toy vehicle 110 is transmitted by electronics aboard the mobile toy vehicle 110 across the wireless communication connection to the portable gaming system 130. The portable gaming system 130 receives the video data from the video camera 112 and incorporates the video data into the visual display 140.

b. Gaming System

The portable gaming system 130 is a handheld computer controlled apparatus that includes one or more computer processors 132 running gaming software 134, a visual display 140, a communications interface 145, and a user-interface controls 155. The portable gaming system generally also includes an audio display system including speakers and/or headphones. The portable gaming system may also include one or more locative sensors such as a GPS position sensor and/or a magnetometer orientation sensor for determining the position and/or orientation of the gaming system with respect to the physical world.

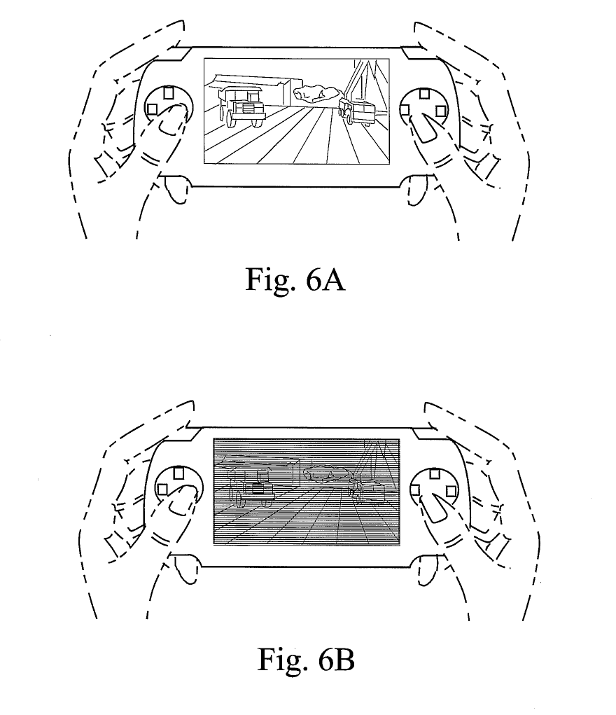

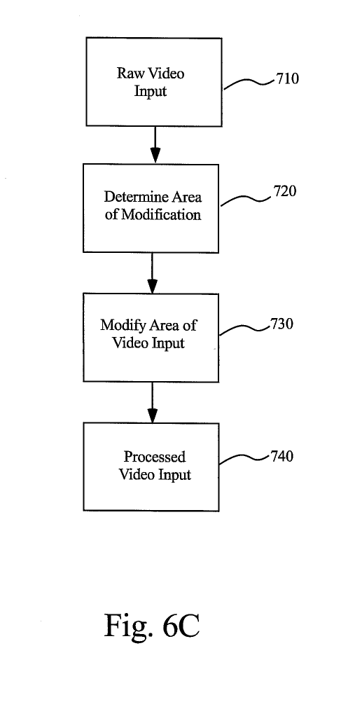

The portable gaming system 130 may be a commercially available device, such as a PlayStation Portable by Sony, Gameboy Advance from Nintendo, a Nintendo DS gaming system from Nintendo, or an N-Gage gaming system from Nokia. An example of a typical portable gaming system 130, a Sony PlayStation Portable, is shown in FIGS. 6-13. Alternately, the portable gaming system 130 may be a device that is dedicated for this particular application.

The gaming processor 132 provides the central control of the subsystems on the gaming console. The visual display 140 is connected to the gaming processor 132. The user-interface controls 155 are connected to the gaming processor 132. The communications interface 145 is connected to the gaming processor 132 and communications link 180.

The gaming software 134 may be implemented using any number of popular computer languages, such as, C, Java, Perl, PHP, and assembly language. The code may also be generated from user libraries specially provided by the manufacturer of the gaminge device. Executable code is loaded on the gaming processor 132. The code may be modified during operation based on inputs and outputs from aforementioned interfaces.

c. Interaction of Gaming System and Mobile Toy Vehicle

The portable gaming system 130 receives and processes video data received from the video camera 112 located on the mobile toy vehicle 110 and updates the gaming software 134.

The portable gaming system 130 sends control signals 150 to the mobile toy vehicle 110, the control signals 150 being used by the mobile toy vehicle 110 to control the motion of the vehicle about the user 160 physical space.

The control signals 150 based in whole or in part upon the user 160 interaction with the manual user-interface controls 155 present upon the portable gaming system 130. For example, in an embodiment the portable gaming system 130 sends control signals 150 to the mobile toy vehicle 110, the control signals 150 based in part upon how the user 160 manipulates the manual user-interface controls 150 that are incorporated into the portable gaming system 130, the control signals 150 controlling the direction and speed by which the mobile toy vehicle 110 moves within the local physical environment of the user. As the mobile toy vehicle 110 moves under the control of the control signals 150, updated video images from the camera upon the mobile toy vehicle 110 are sent back to the portable gaming system 130 and displayed to the user 160 along with other gaming content. In this way the game player can see first-person images sent back from the mobile toy vehicle 110 similar to the images one would see if he or she was scaled to the size of the mobile toy vehicle 110 and riding upon it. The images are a real-time changing perspective view of the local physical space of the user 160 that is incorporated into the displayed gaming action upon the portable gaming system 130. The local view is merged with computer generated gaming content allowing the user 160 to play not just on a screen, but play within his or her view of the physical local space.

A real-time camera image is one that seems to the user that is substantially reflecting the present conditions of the remote mobile toy vehicle. There will generally be a small time delay due to image capture and image communication processes, but this delay is small compared to the time frames required by the human perceptual system.

The mobile toy vehicle 110 is connected to the portable gaming system 130 using the wireless communications interface 180. The gaming software 134 controls the computer processors 132 that are connected to the visual display 140.

The portable gaming system 130 communicates with the mobile toy vehicle 110 over the wireless communications interface 180.

In addition to the controlling the speed and direction of the mobile toy vehicle 110, the control signals from the portable gaming system 130 can optionally control the orientation of the camera relative to the chassis of the mobile toy vehicle 110, the control signals being sent to the mobile toy vehicle 110 from the portable gaming system 130 in response to user 160 manipulations of the manual user-interface controls upon the portable gaming system 130. The relative orientation of the camera with respect to the chassis of the mobile toy vehicle 110 can be achieved in some embodiments by mounting the camera to the chassis of the vehicle through a motor controlled gimbal or turret. In addition to the controlling the relative orientation of the camera with respect to the chassis of the mobile toy vehicle 110, the control signals from the portable gaming system 130 can optionally control the zoom focus of the camera, the control signals being sent to the mobile toy vehicle 110 from the portable gaming system 130 in response to user 160 manipulations of the manual user-interface controls upon the portable gaming system 130.

Other sensors can be optionally mounted upon the mobile toy vehicle 110. Data from these sensors are sent back to the portable gaming system 130 over the wireless communication interface 180, the data from the sensors being used by the game processor 132 within the portable gaming system 130 to update or modify gaming software 134. For example, collision sensors 116 can be mounted upon the mobile toy vehicle 110, the collision sensors 116 detecting if the vehicle collides with a physical object within its local space. The collision sensors 116 can be binary, indicating yes/no if a collision has occurred. The collision sensors 116 can be analog, indicating not just if a collision has occurred but also a magnitude or direction for the collision.

A ranging sensor 115 such as an ultrasound transducer can be mounted upon the mobile toy vehicle 110, the ranging sensor 115 detecting the distance of objects from the mobile toy vehicle 110, the vehicle computer 118 within the mobile toy vehicle 110 sending data representative of the distance back to the portable gaming system 130, the distance information being used by the vehicle computer 118 of the portable gaming system 130 to update the gaming software 134.

A light detector 117 (Visible, UV, or Infra Red) can be mounted upon the mobile toy vehicle 110, the light detector 117 detects if a light of a particular frequency or modulation is shining upon the mobile toy vehicle 110. The vehicle computer 118 located in the mobile toy vehicle 110 sending data representative of the output of the light sensor back to the portable gaming system 130, the sensor information being used by the processor of the portable gaming system 130 to update the gaming software 134.

A vibration sensor 119 (such as an accelerometer) can be mounted upon the mobile toy vehicle 110, the vibration sensor 119 detecting a level of vibration experienced by the mobile toy vehicle 110 as it moves over a particular terrain. The vehicle computer 118 sends data within the mobile toy vehicle 110 sending data representative of the output of the vibration sensor back to the portable gaming system 130, the sensor information being used by the processor of the portable gaming system 130 to update the gaming software 134.

Also a microphone 111 can be mounted upon the mobile toy vehicle 110, the microphone detecting sound signals local to the mobile toy vehicle 110 as it moves about a particular room or environment, the electronics within the mobile toy vehicle 110 sending data representative of the sound signals back to the portable gaming system 130, the sound information being displayed to the user 160 through the portable gaming system 130 along with other processor generated sounds relating to the gaming software 134.

Also position or motion sensors 121 can be mounted upon the mobile toy vehicle 110, the position or motion sensors 121 detecting the relative or absolute distance traveled by the vehicle in a particular direction within the real physical space of the user. The electronics within the mobile toy vehicle 110 sending data representative of the distance or motion back to the portable gaming system 130, the processor 132 upon the portable gaming system 130 updating the gaming action based in part upon the distance or motion data. The position or motion sensors 121 in some embodiments can be relative motion sensors that track the direction and spin of the wheels of the vehicle thereby tracking the relative motion of the vehicle over time. The position or motion sensors 121 can in other embodiments be absolute position sensors, such as GPS sensors, that track the absolute position of the vehicle within the space of the user 160 during operation of the gaming software 134.

Also one or more light sources 123 can be mounted upon the mobile toy vehicle 110, the light source sending a light beam as it moves about a particular room or environment. The light sources may be, for example, visible light sources, UV light sources, or IR light sources, and may optionally be modulated with a carrier frequency. The gaming software 134 enables the light source 123 within the mobile toy vehicle 110.

Example Embodiment of a Mobile Robotic Toy Vehicle

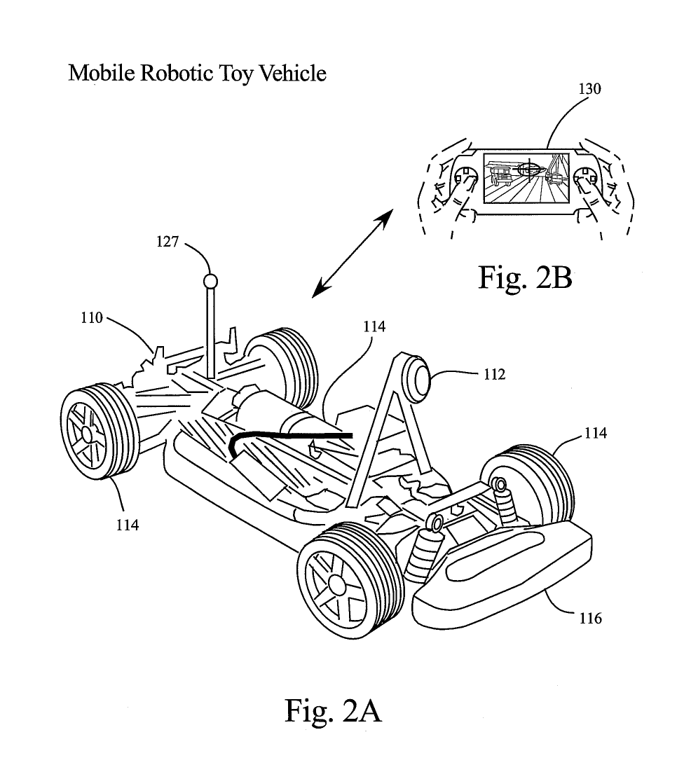

Now referring to FIG. 2 shows an example of a simple mobile toy vehicle 110 with the top cover removed, the mobile toy vehicle 110 in wireless communication with a portable gaming system 130. As shown the mobile toy vehicle 110 is comprised of many components including but not limited to a vehicle chassis with wheels and a suspension, a drive motor, control electronics, communication electronics, an antenna for bi-directional wireless communication with portable gaming system 130, wheels that can be steered under electronic control (actuator to steer wheels not shown), bumpers with bumper sensors (bumper sensors not shown), power electronics, a battery pack, and a video camera 112. Although the example shown in FIG. 2 shows the camera rigidly attached to the frame of the vehicle, other embodiments include additional actuators that allow the camera change its orientation under electronic control with respect to the frame of the vehicle

Although the example shown in FIG. 2 shows a single drive motor, other embodiments may include multiple drive motors, each of the drive motors being selectively activated or deactivated by on-board electronics in response to control signals 150 received from the portable gaming system 130 and in coordination with the game software 134.

Although the examples shown in FIG. 2 show a single camera, multiple cameras are used in other embodiments. Not shown in FIG. 2 are other sensors and actuators that may be included in various embodiments of mobile toy vehicle 110 such as, but not limited to, light sensors 117, microphones 111, speakers, robotic grippers, robotic arm effectors, electro magnets, accelerometers, tilt sensors, pressure sensors, force sensors, optical encoders to track wheel motion, sensors to track steering angle, GPS sensors to track vehicle location, ultrasound transducers to do spatial ranging of objects in the environment, stereo camera systems to provide 3D visual images or ranging data, reflective sensors to identify the surface characteristics of the floor or ground, reflecting sensors for tracking lines drawn or tape laid upon the floor, IR detectors, UV detectors, or vibration sensors.

Also not shown, but optionally included in the mobile toy vehicle 110, is an electronically controllable weapon turret. In some embodiments the electronically controllable weapon turret includes a video camera affixed such that the orientation of the weapon turret is the same as the orientation of the camera aim, giving the user who is viewing the camera image upon his portable gaming system 130 a first person view of what the weapon turret is aimed at. In addition a light emitter can be included upon the weapon turret such that a light (constant or modulated) is shined in the direction that the turret is pointed when a simulated weapon is fired, the light falling upon a light sensor of an opponent vehicle when the turret is appropriately aimed at the opponent mobile robotic vehicle. In this way weapon's fire hit can be determined (as described elsewhere in this document) from one vehicle to another and reported to one or more portable gaming system 130 over the bi-directional communication links. Also not included in FIG. 2, but optionally included in some embodiments of the mobile toy vehicle 110 are the light source 123 to illuminating dark spaces, the headlights being activated or deactivated by on-board electronics in response to control signals 150 received from the portable gaming system 130.

In addition to the portable gaming system 130 running gaming software 134 and the mobile toy vehicle 110 as described throughout this document, other supplemental hardware can be used within the real space to support gaming action. For example, physical targets, beacons, or barriers can be placed about a real physical space to enhance game play. For example a physical target can be a object of a particular shape or color that is placed within the physical playing space and is detected by sensors upon the mobile toy vehicle 110. Detection can be performed using video image data processed by image processing routines running upon the portable gaming system 130. Detection can also be performed using emitter/detector pairs such that an electromagnetic emitter is affixed to the physical target and is detected by appropriate sensors upon the mobile toy vehicle 110. In one embodiment the emitter is infra-red light source such as an LED that is modulated to vary it's intensity at a particular frequency such as 200 HZ. The detector is an infra-red light sensor affixed to the mobile toy vehicle 110 such that it detects infra-red light that is directionally in front of the vehicle. In this way the vehicle can move about, varying its position and orientation under the control of the user as moderated by the intervening game software upon the portable gaming system 130, thereby searching for an infra-red light signal that matches the characteristic 200 Hz modulation frequency. A variety of different frequencies can be used upon multiple different objects within the physical space such that the sensor can distinguish between the multiple different objects. In addition to targets, beacons and barriers can be used to guide a user or limit a user, within a particular playing space.

In addition to targets, beacons, and barriers, other vehicles can be detected using the emitter/detector pair method disclosed herein. For example if a plurality of mobile toy vehicle 110 were used in the same physical space as part of the same game action, each could be a light source 123 affixed with an emitter (ideally on top such that it was visible from all directions) and a light sensor 117 (ideally in front such that it can detect emitters that are located in front of it). Using the sensor each mobile toy vehicle 110 can thereby sense the presence of others within the space. By using a different emission modulation frequency for each of the plurality of mobile toy vehicle 110, each can be distinguished. In this way each player's vehicle can sense the presence of others, even for example, when playing in a dark or dim playing space, or even, depending upon the form of emission, when there are physical obstructions that block optical line of sight between users. In addition, based upon the strength of the signal received by the sensor from the emitter the software running upon the portable gaming system 130 of a particular user can infer the distance to various targets. Such distance information can be displayed graphically upon the screen of the portable gaming system 130, overlaid upon the real video feedback from the mobile toy vehicle 110.

Other Embodiments of the Toy Vehicle

It should be noted that the toy vehicle need not be in the literal form factor of a car or truck, including for example other mobile robot form factors. In addition, the toy vehicle need not be ground-based, including for example a toy plane, a toy submarine, or a toy boat.

Multiple User Play

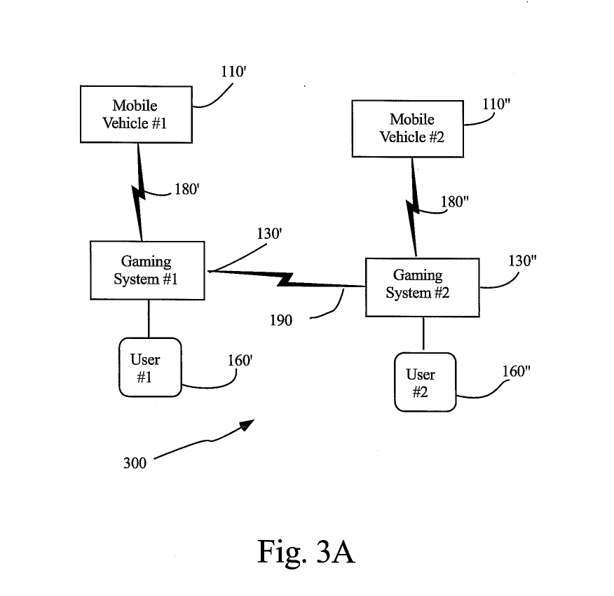

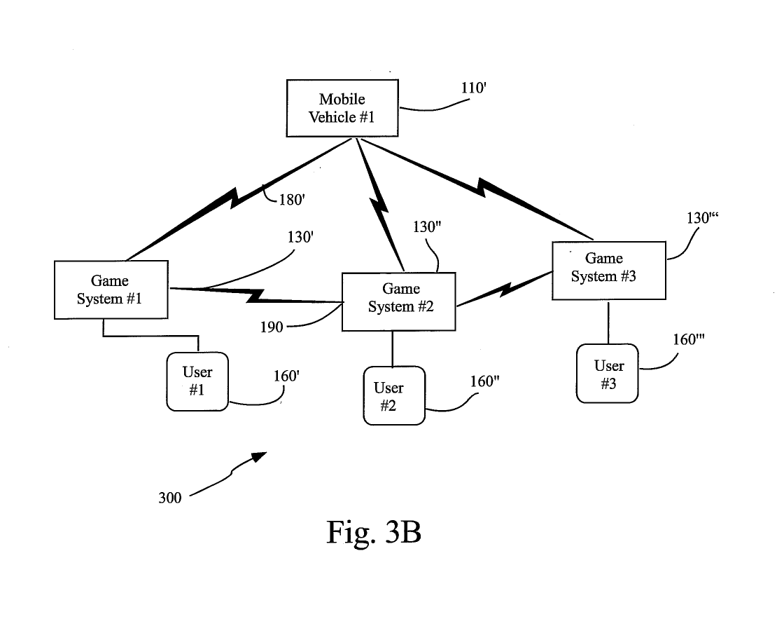

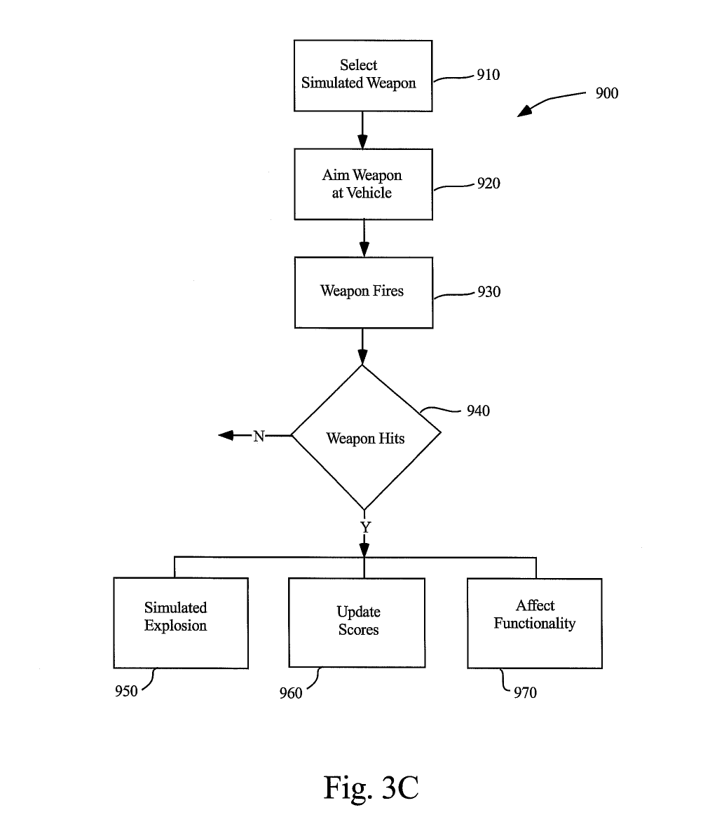

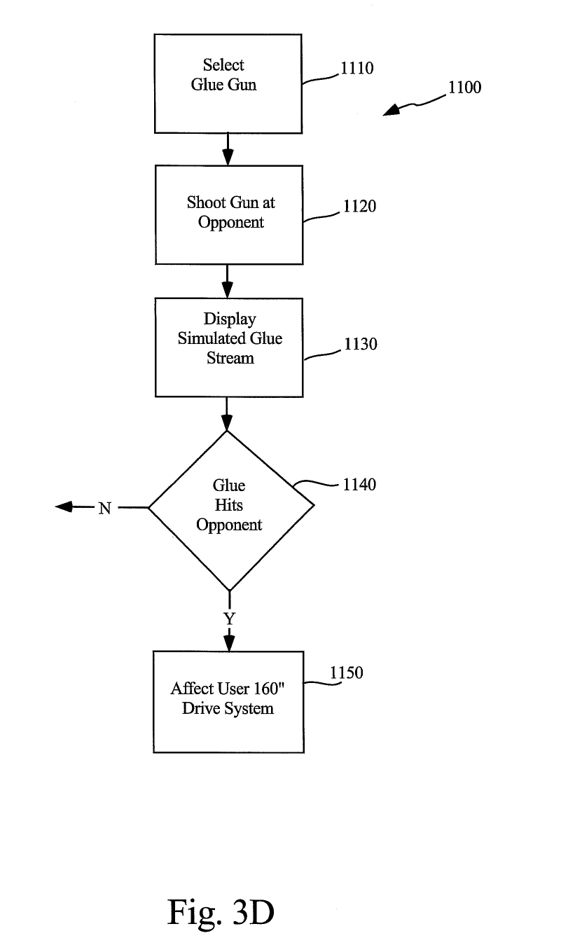

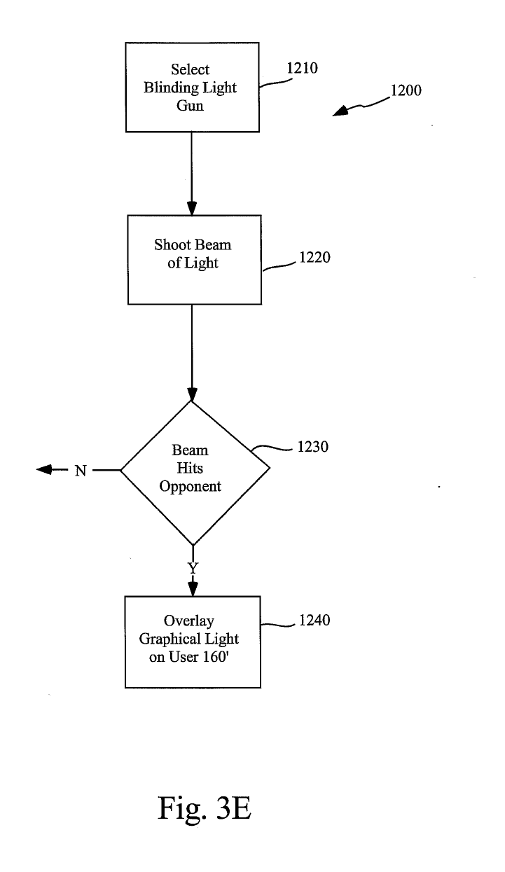

Now referring to FIG. 3a and FIG. 3b that depict various embodiments of multi-user systems.

In FIG. 3a, a system diagram 300 is shown of a two player system where each users 160′, 160″ have mobile toy vehicles 110, 110″ connected each to a portable gaming system 1301, 130″. In this example two users, each controlling their own mobile toy vehicle 110′, 110″ through their own portable gaming system 130′. 130″ can be present in the same local space and can play games that are responsive to sensor data from both mobile toy vehicles 110′, 110″. In the preferred embodiment the portable gaming system 130 of the two users are coordinated through an inter-game communication link 190. This allows the game software (not shown) to be coordinated between both portable gaming systems 130′, 130″ can be coordinated between the two users 160′, 160″. The two users of the two portable gaming system 130′, 130″ can thereby engage a shared gaming experience, the shared gaming experience dependent not just upon the processing of each of their portable gaming system 130′, 130″ but also dependent upon the motions and sensing of each of their mobile toy vehicles 110. This becomes particularly interesting because a first player can see the second player's mobile toy vehicle 110′, 110″ as captured by the video camera (not shown) mounted upon the first player's mobile toy vehicle 110′ and displayed by the first player's portable gaming system 130′. Similarly the second player can see the first player's mobile toy vehicle 110′ as captured by the camera mounted upon the second player's mobile toy vehicle 110″ and displayed by the second player's portable gaming system 130′″. In this way the two users can control their mobile toy vehicles 110′, 110″ to track, follow, compete, fight, or otherwise interact as moderated by the displayed gaming action upon their portable gaming system 130′.

FIG. 3b depicts an alternate embodiment of the multiplayer configuration, a system 400. where three users 160′, 160″, 160′″ operates a corresponding game system 130′, 130″, 130′″, that is connected over the corresponding wireless links 180′, 180″, 180′″ to single mobile toy vehicle 110′. In this scenario the three users 160′, 160″, and 160″ via game software (not shown) in each game system 130′, 130″, and 130′″, engage in shared control of mobile vehicle #1. The shared control may be performed sequentially, each user taking turns controlling the vehicle. The shared control may be performed simultaneously, each user controlling a different feature or function of the mobile vehicle. The shared control may also be collaborative, the plurality of users jointly controlling the mobile robot through a merging of their respective control signals. This may be performed, for example, by averaging the control signals received from the plurality of users when controlling mobile vehicle actions through their gaming systems.

In another embodiment, the system can be designed to support a larger number of users, each with their own gaming systems 130 and their own mobile toy vehicles 110. In addition the mobile toy vehicle 110 need not be identical in form or function.

User to User Interaction

a. Simulated Weapons

Referring now to FIG. 3c, a flowchart 900 depicts the process of selecting and firing simulated weapons 125.

As shown, a simulated weapon is selected 910 for use by the mobile toy vehicle 110. The weapon can aim 920 in preparation of “firing upon” 930 the other user. A simulated weapon 125 such as a light beam 123 that selectively shines from one vehicle in a particular direction based upon the position and orientation of the vehicle and control signals 150 from the users 160′, 160″ and their respective gaming systems 130′, 130″, the control signals being generated in part based upon users 160′, 160″ manipulation of the manual user interface controls 150′, 150″ upon the portable gaming system 130′, 130″.

Whether or not the simulated weapon 125 hits 940 the other of the two mobile toy vehicles 110′, 110″ is determined by light detectors 117 upon one or both of the mobile toy vehicle 110′, 110″. For example in one embodiment the light detector 117 upon a mobile toy vehicle 110 is used to determine of that vehicle has been hit by a simulated weapon represented by a beam of light shot by another mobile toy vehicle 110. If a hit was determined (as a result of the light detector 117 triggering, for example, above a certain threshold or with a certain modulation, data is sent to the gaming systems 130′, 130″ of one or both users and the game software 134′, 134″ is updated based upon the data received from the mobile toy vehicles 110′, 110″. The updating of the game software 134′, 134″ can include, for example, the portable gaming system 130′, 130″ of one or both users displaying a simulated explosion image overlaid upon the camera image that is being displayed upon the screen of the gaming systems 130′, 130″ (or systems). The updating of the game software 134′, 134″ can also include, for example, the portable gaming system 130′, 130″ of one or both users 160′, 160″ displaying a simulated explosion 950 sound upon the portable gaming system 130′, 130″ The updating of game software 134 can also include, for example, user scores 960 being updated upon the portable gaming system 130′, 130″. The updating of game software 134 can also include the computation of or display of simulated damage upon the portable gaming system 130′, 130″, the simulated gaming creating a condition of hampered functionality 970 of the mobile toy vehicle.

For example, if a player's vehicle has suffered simulated damage (as determined by the software running upon one or more portable gaming system 130) that vehicle can be imposed with hampered functionality 970. The hampered functionality 970 could limit the user's ability to control his or her mobile toy vehicle 110 through the control signals 150 being sent from his or her portable gaming system 130 in response to the user's manipulation of the manual user-interface controls upon his or her portable gaming system 130. In this way the game software can impact the real-world control of the physical toy that is present in the users physical space, merging the on-screen and off-screen play action.

If a user's vehicle has suffered hampered functionality 970 as determined by the gaming software 134 running upon that user's portable gaming system 130, the control signals sent to that user's mobile toy vehicle 110 can be limited or modified such that the vehicle has reduced turning capability, reduce speed capability, or other reduced control capability.

In addition, if a user's vehicle has suffered hampered functionality 970 as determined by the gaming software 134 running upon that user's portable gaming system 130, the display of sensor data received from that user's mobile toy vehicle 110 can be limited or modified such that the vehicle has reduced sensor feedback capability for a period of time as displayed to the user 160 through his or her portable gaming system 130. The reduced sensor feedback capability can include, for example, such as reduced video 140 feedback display fidelity, reduced microphone 111 feedback display fidelity, eliminated camera 112 feedback display, eliminated microphone 111 feedback display, reduced or eliminated distance sensor 115 capability, reduced or eliminated collision sensor 116 capability, or reduced or eliminated vibration sensor 119 capability.

If a user's vehicle has suffered hampered functionality 970 as determined by the gaming software running upon that user's portable gaming system 130, the gaming software 134 can reduce or eliminate the simulated weapon 125 capabilities of that player's vehicle for a period of time. This can be achieved by reducing in the gaming software 134 the simulated range of the vehicle's simulated weapons, reducing in software the simulated aim of the vehicle's simulated weapons 125, or eliminated the weapon capability of the vehicle all together for a period of time.

b. Glue Gun

Referring now to FIG. 3d, a flowchart 1100 depicts the process of selecting 1110 and firing simulated weapon 125 known as the “Glue Gun”.

For example a user 160 can select a weapon from a pool of simulated weapons 125 by using the user interface controls 140 upon his or her portable gaming system 130. The weapon he or she might choose might be a “glue gun” 1110 which can shoot a simulated stream of glue 1120 at an opponent. This may cause a graphical display of a glue stream being overlaid upon the real video captured from that user's mobile toy vehicle 110. Depending upon sensor data from the mobile toy vehicle 110, it may be determined in software if the glue stream hit the opponent. If the opponent was hit, 1140 the simulated glue weapon causes the vehicle of the opponent to function as if it was stuck in glue using the methods described above.

For example, the user 160 who is controlling the vehicle that was hit by the simulated glue weapon may only be able to move his or her mobile toy vehicle 110 at reduced speed 1150 and in reduce directions until that vehicle has moved a sufficient distance as to pull free of the simulated glue (as monitored by the gaming software running upon one or more portable gaming system 130). In this way simulated computer generated effects can be merged with physical toy action to create a rich on-screen off-screen gaming experience.

In an alternate embodiment, the mobile toy vehicle that fires the simulated weapon includes a light sensor or other emission detector that is aimed in the direction of the mock weapon (i.e. in the direction of a mock gun turret upon the toy vehicle). The opposing vehicle includes a light emitter (or other emitter compatible with the emission detector) upon one or more outer surfaces of the vehicle. In such a configuration the system can determine of the mock weapon is aimed at the opposing vehicle if the light sensor (or other emission detector) detects the presence of the light emitter (or other compatible emitter) in its line of sight.

c. Blinding Light Gun

Referring now to FIG. 3d, a flowchart 1200 depicts the process of selecting 1210 and firing simulated weapon 125 known as the “Blinding Light Gun”.

With respect to the example above, the user 160 might choose other weapons through the user 160 interface upon the portable gaming system 130. He or she might choose a “blinding light gun” that shoots 1210 a simulated beam of bright light at an opponent. This may cause a graphical display of a bright beam of light being overlaid upon the real video captured from that user's mobile toy vehicle 110. Depending upon sensor data from the mobile toy vehicle 110, it may be determined in software if the blinding light beam hit the opponent who was aimed at. If the opponent was hit 1230, the simulated blinding light weapon causes the visual feedback displayed to the player who is controlling that vehicle to be significantly reduced or eliminated all together.

For example, the player's video feedback 1240 from the camera on his or her vehicle could turn bright white for a period of time, effectively blinding the user 160 of his or her visual camera feedback for that period of time. If the light beam was not a direct hit, only a portion of the user's visual display of camera feedback might turn bright white. Alternatively instead of that user's camera feedback display being obscured by the computer generated image of bright white, the camera feedback might be displayed with reduced fidelity, being washed out with brightness but still be partially visible (as controlled by the gaming software 134 running upon one or more portable gaming system 130). In this way simulated computer generated effects can be merged with physical toy action to create a rich on-screen off-screen gaming experience.

d. Weapons Cache

With respect to the simulated weaponry described above, again the simulated scenario created by the gaming software 134 can moderate the functionality of the mobile toy vehicle 110. For example, the gaming software 134 can provide limited ammunition levels for each of various weapons and when such ammunition levels are expended the user 160 is no longer able to fire simulated weapons by commanding the mobile toy vehicle 110 through the portable gaming system 130. In this way simulated game action moderates the physical play action of the toy, again merging computer generated gaming scenarios with physical toy action to create a rich on-screen off-screen gaming experience.

e. Fuel Supply

In addition to weaponry effecting the gaming action and moderating under software control a user's ability to control his or her mobile toy vehicle 110 through the portable gaming system 130 or moderating under software control a user's feedback display from sensors aboard his or her mobile toy vehicle 110, other simulating gaming factors can influence both the control of and displayed feedback from the mobile toy vehicle 110. For example the gaming software running upon one or more portable gaming system 130 can track simulated fuel usage (or simulated power usage) by the mobile toy vehicle 110 and can cause the mobile toy vehicle 110 to run out of gas (or power) when the simulated fuel or power is expended. This can be achieved by the gaming software moderating the control signals 150 from the portable gaming system 130 to the mobile toy vehicle 110 such that it ceases the ability of the vehicle to move (or reduces the ability of the vehicle to move) when the mobile toy vehicle 110 has run out of simulated fuel or simulated power. The ability to move can also be restored under software control based upon the gaming action, such as the simulated powering of solar cells or the simulated discovery of a fuel or power source. In this way simulated computer gaming action can be merged with physical toy action to create a rich on-screen off-screen gaming experience. Similarly various functions performed by the mobile toy vehicle 110, whether it is real or simulated motion functions, real or simulated sensing functions, or real or simulated weapon function, can be made to expend simulated fuel or energy at different rates. In this way the game player who is controlling the real and simulated functions of the vehicle must manage his or her usage of real and simulated functions such that fuel is not expended at a rate faster than it is found or generated within the simulated gaming scenario.

Vehicle Interaction with Simulated Objects

As described in the paragraphs above, the mobile toy vehicle 110 that is controlled by the user to engage the gaming experience has both real and simulated functionality that is depicted through the merged on-screen off-screen gaming methods. The real functions are enacted by the real-world motion and real-world sensing of the mobile toy vehicle 110 as described throughout this document. The simulated functions are imposed or overlaid upon the real-world experience by the gaming software 134 running upon the portable gaming system 130. The simulated functions can moderate the real-world functions, limiting or modifying the real-world motion of the mobile toy vehicle 110 or limiting or modifying the feedback from real-word sensors upon the mobile toy vehicle 110.

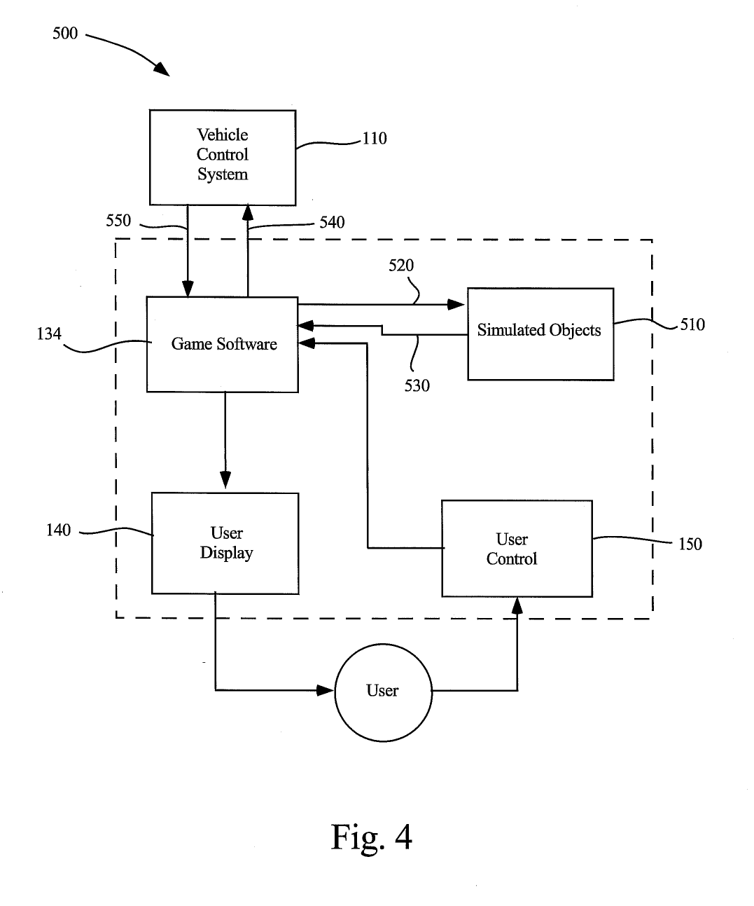

Now referring to FIG. 4, a simplified block diagram of the mobile toy vehicle 110, the game software 134, the simulated inputs 510, the user display 140, and the user control 150 are shown. The simulated inputs 510 refer to a software module that stores and maintains a list of simulated functions 610.

The game software 134 is connected to the mobile toy vehicle 110 and the simulated inputs 510. The game software 134 is also connected to the user display 140 and the user controls 150. During operation, the mobile toy vehicle 110 sends vehicle information 550 to the gaming software 134. The mobile toy vehicle 110 receives control information 540. The game software 134 sends state information 520 and receives simulated inputs 530 from the simulated objects 510 module. The user interacts with the game software 134 using the user display 140 and the under user control 150. The game software also receives a camera feed from the vehicle 110 and displays it to the user upon the user display 140. The game software is generally operative to overlay graphics upon the display of said camera feed, as described elsewhere in this document, to provide a mixed on-screen off-screen gaming experience.

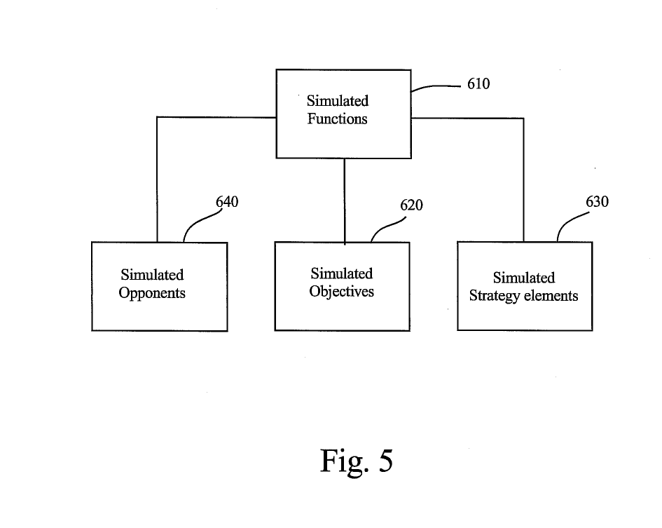

Now referring to FIG. 5, the simulated functions 610 also expand upon the gaming scenario, creating simulated objectives 620 and simulated strategy elements 630 such as simulated power consumption, simulated ammunition levels, simulated damage levels, simulated spatial obstacles and or barriers, and simulated destinations that must be achieved to acquire points or power or ammunition or damage repair. In addition the simulated functions 610 can include simulated opponents 640 that are displayed as overlaid graphical elements upon or within or along side the video feedback from the real-world cameras. In this way a user can interact with real opponents or real teammates in a computer generated gaming experience that also includes simulated opponents or simulated teammates.

Below is additional description of how this merging of simulated gaming scenarios and real-world mobile toy vehicle 110 control are merged into a combined on-screen off-screen gaming experience by the novel methods and apparatus disclosed throughout this document.

In the descriptions below the phrase “simulated vehicle” is meant to refer to the combined real-world functions and features of the mobile toy vehicle 110 with the simulated features and functions overlaid upon display or otherwise introduced into the control interface between the user and the mobile robot toy vehicle by the gaming software. In this way the “simulated vehicle” is what the user experiences and it is a merger of the features and functions of both the real world robotic toy and the simulated computer gaming content.

Simulated Lighting Conditions

One method enabled within certain embodiments of the present invention merges simulated gaming software 134 with real-world mobile toy vehicle 110 by adjusting the display of visual feedback data received from the remote camera aboard the mobile robot toy vehicle based upon simulated lighting characteristics of the simulated environment represented within the computer generated gaming scenario. For example, when the computer generated gaming scenario is simulating a nighttime experience, the display of visual feedback data from the remote camera is darkened or limited to represent only the small field of view illuminated by simulated lights aboard the simulated vehicle. Similarly, simulated inclement weather conditions can be represented by degrading the image quality of the displayed camera images. This can be used, for example, to represent fog, smoke, rain, snow, etc in the environment of the vehicle.

FIG. 6a shows raw camera footage displayed upon a portable gaming device as received from a camera aboard a mobile robot toy vehicle over a communication link.

FIG. 6b shows the camera footage as modified by gaming software such that it is darkened to represent a simulated nighttime experience.

Now referring to FIG. 6c a flow chart demonstrates how the modification of the raw video input. The raw video input 710 is sent to spatial limiting module 720. The spatial limiting module 720 determines the area of raw video input 710 that will be modified. For example, the video input 710 could be modified by gaming software such that it is darkened and limited to a small illuminated area directly in front of the vehicle to represent a nighttime scene that is illuminated by simulated lights upon the remote vehicle. The modify pixel intensity module 730 change the pixels sent from the area modification module 720 are then sent to the gaming software 134.

There are various methods by which an image can be processed and thereby darkened or lightened or tinted to correspond with simulated lighting conditions within the computer generated gaming scenario. As another example the image displayed upon the portable gaming system 130 is tinted red to simulate a gaming scenario that takes place upon the surface or mars. As another example the image displayed upon the portable gaming system 130 is tinted blue to simulate an underwater gaming experience. In these ways the simulated game action moderates the physical play action of the toy, again merging computer generated gaming scenarios with physical toy action to create a rich on-screen gaming experience.

Simulated Terrain and Backgrounds

Another method enabled within some embodiments of the present invention merges simulated gaming action with real-world mobile robot control and feedback by merging of computer generated graphical images with the real-world visual feedback data received from the remote camera aboard the mobile robot toy vehicle to achieve a composite image representing the computer generated gaming scenario. For example, the computer generated gaming scenario might be a simulated world that has been devastated by an earthquake. To achieve a composite image representing such a computer generated scenario the display of visual feedback data from the remote camera is augmented with graphically drawn earthquake cracks in surfaces such as the ground, walls, and ceiling. FIG. 6a shows raw camera footage displayed upon a portable gaming device as received from a camera aboard a mobile robot toy vehicle over a communication link.

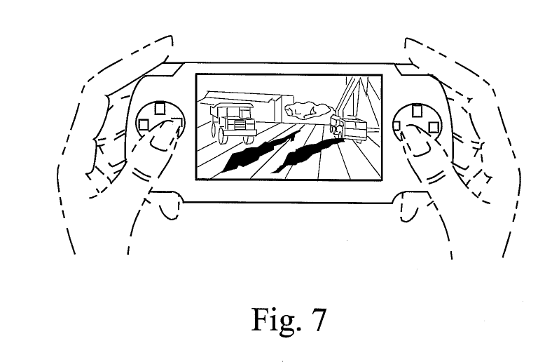

FIG. 7 shows the camera footage as augmented by gaming software, graphically drawn cracks in the floor are added to represent a earthquake ravaged gaming experience. Other simulated terrain images or background images or foreground objects, targets, opponents, or barriers can be drawn upon or otherwise merged with the real-world video footage. In this way simulated game action moderates the physical play action of the toy, again merging computer generated gaming scenarios with physical toy action to create a rich on-screen off-screen gaming experience.

Simulated Weapons

A method enabled within certain embodiments of the present invention merges simulated gaming action with real-world mobile robot control and feedback by overlaying computer generated graphical images of weapon targeting, weapon fire, or resulting weapon damage upon the real-world visual feedback data received from the remote camera aboard the mobile toy vehicle 110 to achieve a composite image representing the computer generated gaming scenario. For example, the computer generated gaming scenario might enable the simulated vehicle with weapon capabilities.

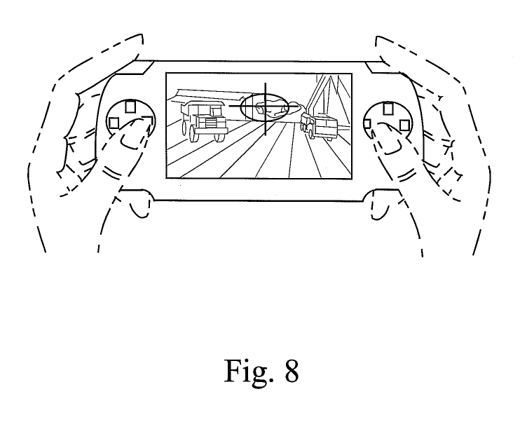

Now referring to FIG. 8, to enable targeting of the weapon within the real-world scene a graphical image of a targeting crosshair is generated by the gaming software on the portable gaming system 130 and displayed as an overlay upon the real world camera footage received from the mobile toy vehicle 110. As the user moves the mobile toy vehicle 110 by manipulating the buttons upon the gaming system (for example by pressing forward, back, left, or right) the video image pans across the real world scene. As the video image moves, the cross hairs target different locations within the real world space shown in FIG. 8.

As shown in FIG. 8 the vehicle is pointed in a direction such that the targeting crosshair is aimed upon the bean bag in the far corner of the room. The user may choose to fire upon the bean bag by pressing an appropriate button upon the portable game system. A first button press selects an appropriate weapon from a pool of available weapons. A second button press fires the weapon at the location that was targeted by the cross hairs. Upon firing the gaming software running upon the portable gaming system 130 generates and displays a graphical image of a laser beam overlaid upon the real-world image captured by the camera upon the mobile toy vehicle 110.

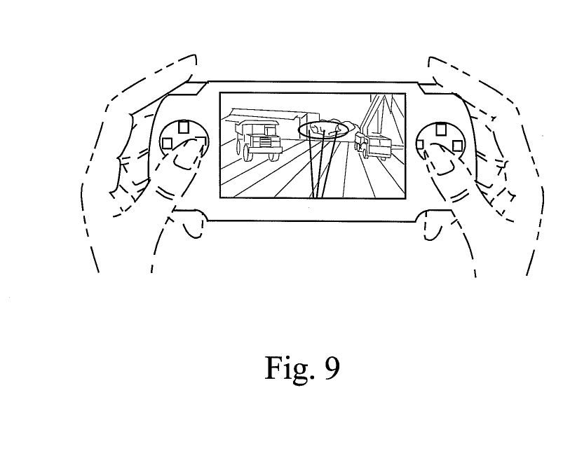

As shown in FIG. 9, the overlaid image of the laser weapon might appear as shown in FIG. 9. This overlaid computer generated laser fire experience is followed by a graphical image and sound of an explosion as the weapon has its effect. When the explosion subsides, a graphical image of weapon damage is overlaid upon the real-world video image captured from the remote camera.

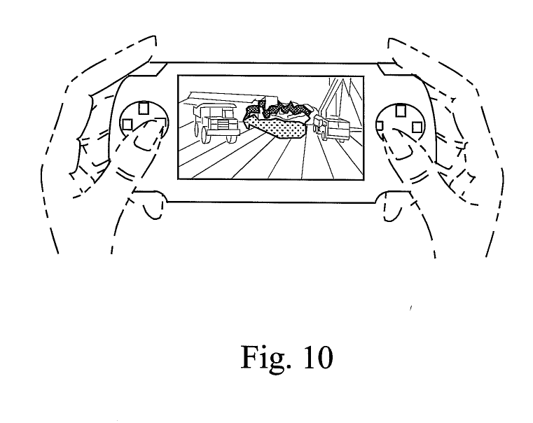

As shown in FIG. 10, an example of an overlaid weapons damage image is shown below in FIG. 10. In this way simulated game action moderates the physical play action of the toy, again merging computer generated gaming scenarios with physical toy action to create a rich on-screen off-screen gaming experience. For example the firing of weapons is moderated by both the real-world position and orientation of the remote mobile toy vehicle 110 and the simulation software running upon the portable gaming system 130.

A further method by which the simulated gaming action running as software upon the portable gaming system 130 can moderate combined on-screen off-screen experience of the user is through the maintenance and update of simulated ammunition levels. To enable such embodiments the gaming software running upon the portable gaming system 130 stores and updates variables in memory representing one or more simulated ammunition levels, the ammunition levels indicating the quantity of and optionally the type of weapon ammunition stored within or otherwise currently accessible to the simulated vehicle. Based upon the state and status of the ammunition level variables, the gaming software running upon the portable gaming system 130 determines whether or not the simulated vehicle can fire a particular weapon at a particular time. If for example the simulated vehicle is out of ammunition for a particular weapon, the weapon will not fire when commanded to do so by the user through the user interface. In this way the firing of weapons is moderated by both the real-world position and orientation of the remote mobile toy vehicle 110 and the simulation software running upon the portable gaming system 130.

The word “weapon” as described above is used above need not simulate traditional violent style weapons. For example, weapons as envisions by the current invention can use non-violent projectiles including but not limited to the simulated firing of tomatoes, the simulated firing of spit balls, or the simulated firing of snow balls. In addition, the methods described above for the firing of weapons can be used for other non-weapon related activities that involve targeting or firing such as the control of simulated water spray by a simulated fire-fighting vehicle or the simulated projection of a light-beam by a spot-light wielding vehicle.

Simulated Fuel, Power, and Damage Levels

Another method enabled within certain embodiments of the present invention merges simulated gaming action with real-world mobile robot control and mobile robot feedback by moderating a user's ability to control the mobile robot toy vehicle based upon simulated fuel levels, power levels, or damage levels.

To enable such embodiments the gaming software 134 running upon the portable gaming system 130 stores and updates variables in memory representing one or more simulated fuel levels, power levels, or damage levels associated with the simulated vehicle being controlled by the user. Based upon the state or status of the variables, the gaming software 134 running upon the portable gaming system 130 modifies how a user's 160 input (as imparted upon the manual user interface on the portable gaming system 130) are translated into control of the remote vehicle.

In some embodiments the gaming software 134 running upon the portable gaming system 130 achieves the modification of how a user's input gestures are translated into the control of the vehicle by adjusting the mapping between a particular input gesture and a resulting command signal sent from the portable gaming system 130 to the mobile toy vehicle 110. For example, when a variable stored within the portable gaming system 130 indicates that there is sufficient fuel or sufficient power stored within the simulated vehicle to power the simulated vehicle, a particular mapping is enabled between the user's input gesture (as imparted upon the manual user interface on the portable gaming system) and the motion of the vehicle. The mapping may be such that when the user presses a forward button upon the portable gaming system a control signal is sent to the mobile toy vehicle 110 causing it to move forward. The mapping may also be such that when a user presses a backward button upon the portable gaming system 130 a control signal is sent to the mobile toy vehicle 110 causing it to move backward. The mapping may also be such that when a user presses a left button on the portable gaming system 130 a control signal is sent to the mobile toy vehicle 110 causing it to turn left or veer left. The mapping may also be such that when a user presses a right button on the portable gaming system 130 a control signal is sent to the mobile toy vehicle 110 causing it to turn right or veer right. This mapping may be modified, however, using the methods disclosed herein, based upon the simulated fuel level, power level, or damage level, stored as one or more variables within the portable gaming system 130. For example, if the power level or fuel level falls below some threshold value, the software running on the portable gaming system 130 may be configured to modify the mappings between button presses and the motion of the mobile toy vehicle 110 as achieved through the sending of control signals 150 from the portable gaming system 130 and the mobile toy vehicle 110. In a common embodiment, when the power level or fuel level falls below some threshold value, the mapping is modified such that reduced motion or no motion of the mobile toy vehicle 110 is produced when the user presses one or more of the buttons described above. This may be achieved in some embodiments by sending reduced motion values or zero motion values within the control signals 150 when the simulated fuel level or simulated power level falls below some threshold value (to achieve reduced motion or no motion of the real robotic toy vehicle respectively). Similarly, if the simulated damage level (as stored in one or more variables within the portable gaming system 130) rises above some threshold value, the software running on the portable gaming system 130 may be configured to modify the mappings between button presses and the motion of the mobile toy vehicle 110 as achieved through the sending of control signals 150 from the portable gaming system 130 and the mobile toy vehicle 110. In a common embodiment, when the damage level rises above some threshold value, the mapping is modified such that reduced motion or erratic motion or no motion of the mobile toy vehicle 110 is produced when the user presses one or more of the buttons described above. This may be achieved in some embodiments by sending reduced motion values or distorted motion values or zero motion values within the control signals 150 when the simulated damage level rises above some threshold value (to achieve reduced motion, erratic motion, or no motion of the real robotic toy vehicle respectively).

The example given in the paragraph above uses button presses as the means by which the user inputs manual commands for controlling the mobile toy vehicle 110 as moderated by the intervening gaming software 134. It should be noted that instead of buttons, a joystick, a trackball, a touch pad, dials, levers, triggers, sliders, and other analog or binary controls upon the portable gaming system 130 or interfaced with the portable gaming system 130 can be used. For example a joystick could be used by the user to command a direction and speed of the mobile toy vehicle 110, a particular position of the joystick mapping to a particular the direction and speed of the vehicle. However, as described above, such a mapping can be modified by the gaming software based upon simulated fuel levels, power levels, or damage levels associated with the simulated vehicle.

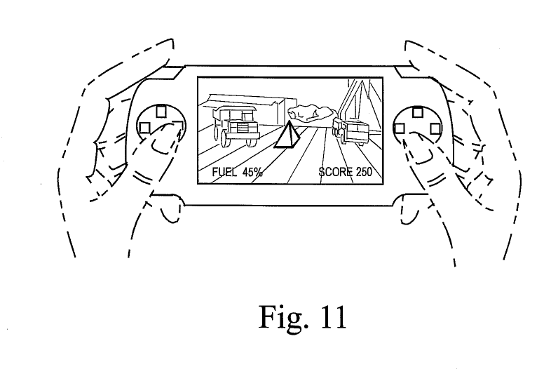

Referring to FIG. 11, depicts a Portable Gaming System displaying live real-time video received over a communication link from a camera mounted upon a mobile robotic toy vehicle, the motion of said vehicle being controlled by said user through the manipulation of the buttons shown on said portable gaming system below. Simulated objects can be placed within gaming space as simulated graphical overlays upon the real-time video image. As shown below, a pyramid is drawn as a graphical target the user has been seeking as he drove the vehicle around his house. Upon finding the target in this room it is drawn as shown below. Also shown below are graphical gaming status information displayed as overlaid upon the real-time video from the camera on the mobile robotic toy vehicle. In this example below the graphical gaming status information includes current fuel level and current score information.

Simulated damage may be incurred as a result of collisions with simulated objects such as the overlaid graphical object shown in the figure. This object is drawn as a pyramid although one will appreciate that a wide variety of simulated graphical elements may be overlaid upon the real-world imagery supplied by the camera feed. Such graphical elements may be three dimensional as shown in FIG. 11.

As for the specific technique by which three-dimensional graphical imagery may be overlaid upon a video feed, commercial software exists for the seamless merging of real-time video with 3d graphics. For example D'Fusion software from Total Immersion allows for real-time video to be merged with 3D imagery with strong spatial correlation. As another example, the paper Video See-Through AR on Consumer Cell-Phones by Mathias Mohring, Christian Lessig, and Oliver Bimber of Bauhaus University which is hereby incorporated by reference, presents a method of using low cost cameras (such as those in cell phones) and low cost processing electronics (such as those in cell phones) to create composite images that overlay 3D graphics upon 2D video images captured in real time.

Simulated Shields

Another method enabled within certain embodiments of the present invention that merges simulated gaming action with real-world mobile robot control is the generation and use of simulated shields to protect the combined real/simulated vehicle from weapons fire or other potentially damaging simulated objects. To enable such embodiments the gaming software running upon the portable gaming system 130 stores and updates variables in memory representing one or more simulated shield levels (ie shield strengths) associated with the simulated vehicle being controlled by the user.

Based upon the state and status of the shield variables, the gaming software running upon the portable gaming system 130 modifies how simulated damage is computed for the vehicle when the vehicle is hit by weapons fire and when the vehicle encounters or collides with a simulated object that causes damage. In this way the imparting of damage (which as described previously can moderate or modify how the robotic mobile toy vehicle responds when controlled by the user through the portable gaming system 130) is further moderated by simulated gaming action. Furthermore the presence or state of the simulated shields can effect how the player views the real camera feedback or real sensor feedback from the mobile toy vehicle 110. For example, in some embodiments when the shields are turned on by a player, the camera feedback displayed to that user is degraded as displayed upon the portable gaming system 130. This computer generated degradation of the displayed camera feedback represents the simulated effect of the camera needing to see through a shielding force field that surrounds the vehicle. Such degrading can be achieved by distorting the camera image, introducing static to the camera image, blurring the camera image, reducing the size of the camera image, adding a shimmering halo to the camera image, reducing the brightness of the camera image, or otherwise degrading the fidelity of the camera image when the simulated shield is turned on. This creates additional gaming strategy because when the shield is on the vehicle is safe from opponent fire or other potentially damaging real or simulated objects, but this advantage is countered by a the disadvantage of having reduced visual feedback from the cameras as displayed upon the portable gaming system 130.

Simulated Terrain Features

Another method enabled within certain embodiments of the present invention merges simulated gaming action with real-world mobile robot control and mobile robot feedback by moderating a user's ability to control the mobile robot toy vehicle based upon simulated terrain features, simulated barriers, simulated force fields, or other simulated obstacles or obstructions.

To enable such embodiments the gaming software running upon the portable gaming system 130 stores and updates variables in memory representing one or more simulated terrain features, simulated barriers, simulated force fields, or other simulated obstacles or obstructions. The variables can describe the simulated location, simulated size, simulated strength, simulated depth, simulated stiffness, simulated viscosity, or simulated penetrability of the terrain features, barriers, force fields, or other obstacles or obstructions. Based upon the state or status of the variables and the simulated location of the simulated vehicle with respect to the terrain features, barriers, force fields, obstacles or obstructions, the gaming software running upon the portable gaming system 130 modifies how a user's input gestures (as imparted upon the manual user interface on the portable gaming system 130) are translated into control of the remote vehicle.

In some embodiments the gaming software running upon the portable gaming system 130 achieves the modification of how a user's input gestures are translated into the control of the vehicle by adjusting the mapping between a particular input gesture and a resulting command signal sent from the portable gaming system 130 to the mobile toy vehicle 110. For example, when the variables stored within the portable gaming system 130 indicate that the vehicle is on smooth terrain and that there are no simulated barriers or obstructions within the path of the simulated vehicle, a particular mapping is enabled between the user's input gesture (as imparted upon the manual user interface on the portable gaming system 130) and the motion of the vehicle. The mapping may be such that when the user presses a forward button upon the portable gaming system 130 a control signal is sent to the mobile toy vehicle 110 causing it to move forward. The mapping may also be such that when a user presses a backward button upon the portable gaming system 130 a control signal is sent to the mobile toy vehicle 110 causing it to move backward. The mapping may also be such that when a user presses a left button on the portable gaming system 130 a control signal is sent to the mobile toy vehicle 110 causing it to turn left or veer left. The mapping may also be such that when a user presses a right button on the portable gaming system 130 a control signal is sent to the mobile toy vehicle 110 causing it to turn right or veer right. This mapping may be modified, however, using the methods disclosed herein, based upon the presence of simulated non-smooth terrain features, barriers, obstacles, or obstructions as indicated by as one or more simulation variables within the portable gaming system 130. For example, when the variables stored within the portable gaming system 130 indicate that there is a simulated barriers or obstructions within the path of the simulated vehicle, the software running on the portable gaming system 130 may be configured to modify the mappings between button presses and the motion of the mobile toy vehicle 110 as achieved through the sending of control signals 150 from the portable gaming system 130 and the mobile toy vehicle 110. In a common embodiment, when there is a simulated barrier or obstruction within the path of the simulated vehicle, the mapping is modified such that reduced motion or no motion of the mobile toy vehicle 110 is produced when the user presses one or more of the buttons that would command the vehicle to move into or through the barrier or obstruction. This may be achieved in some embodiments by sending reduced motion values or zero motion values within the control signals 150 (to achieve reduced motion or no motion of the real robotic toy vehicle respectively).

When the variables stored within the portable gaming system 130 indicate that there a simulated bumpy terrain, muddy terrain, sandy terrain, or other difficult to move across terrain under the simulated vehicle at a particular time, the software running on the portable gaming system 130 may be configured to modify the mappings between button presses and the motion of the mobile toy vehicle 110 as achieved through the sending of control signals 150 from the portable gaming system 130 and the mobile toy vehicle 110. In a common embodiment, when the simulated terrain is determined to be difficult to move across by the software running on the portable gaming system 130, the mapping is modified such that reduced motion or erratic motion or no motion of the mobile toy vehicle 110 is produced when the user presses one or more of the buttons described above. This may be achieved in some embodiments by sending reduced motion values or distorted motion values or zero motion values within the control signals 150 (to achieve reduced motion, erratic motion, or no motion of the real robotic toy vehicle respectively).

The use of “button presses” as the means by which the user inputs manual commands for controlling the mobile toy vehicle 110 as moderated by the intervening gaming software are not limited to buttons. Alternate user interfaces include a joystick, a trackball, a touch pad, dials, levers, triggers, sliders, and other analog or binary controls upon the portable gaming system 130 or interfaced with the portable gaming system 130 can be used. For example a joystick could be used by the user to command a direction and speed of the mobile toy vehicle 110, a particular position of the joystick mapping to a particular the direction and speed of the vehicle. However, as described above, the mapping can be modified by the gaming software based upon simulated terrain features, barriers, force fields, obstacles, or obstructions present within the simulated environment of the simulated vehicle.

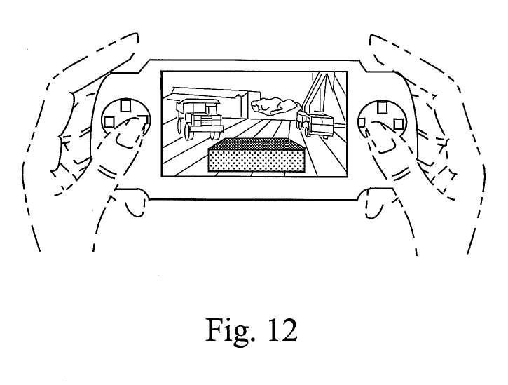

Simulated terrain features, simulated barriers, simulated force fields, or other simulated obstacles or obstructions can be drawn by the software running on the portable gaming system 130 and overlaid upon the real video imagery sent back from the mobile toy vehicle 110. Such a barrier is shown in FIG. 12 as a graphical overlay displayed upon the real video feedback from the mobile toy vehicle 110.

The mobile toy vehicles described herein are rolling vehicles that work by selectively powering wheels, other forms of mobility are useable within the context of this invention. For example mobile toy vehicle 110 can use treads and other rolling mechanisms. Mobile toy vehicle 110 can also employ movable legs as their means of mobility. Furthermore the mobile toy vehicle 110 need not be ground based vehicles but can be flying vehicles or floating vehicles such as toy planes or toy boats respectively. Also, although a single camera image is used in the examples described above, stereo camera images can be employed upon the mobile toy vehicle 110 the stereo camera images providing 3D visual images to users and optionally providing 3D spatial data to the portable gaming system 130 for use by the simulation software for coordinating real-world spatial locations with the simulated location of simulated objects.

Sound Generation in the Remote Toy Vehicle Space:

The mobile toy vehicle 110 as described throughout this document can include additional means for interacting with the real environment around it such as having onboard speakers through which the mobile toy vehicle 110 can broadcast sound into its local environment. The sound signals that are emitted through the speakers on board the mobile toy vehicle 110 can include data transmitted to the vehicle from the portable gaming system 130 over the communication interface. The sound signals can include game-related sound effects such as engine sounds, explosion sounds, weapon sounds, damage sounds, alarm sounds, radar sounds, or creature sounds. The sounds can be transmitted as digital data from the portable gaming system 130 to the mobile toy vehicle 110 at appropriate times as determined by the simulation software running upon the portable gaming system 130. The sound signals are often transmitted by the portable gaming system 130 in coordination with gaming action simulated upon the portable gaming system 130. The sounds can also be stored as digital data upon the mobile toy vehicle 110 and accessed at appropriate times in accordance with control signals 150 sent from the portable gaming system 130 and in coordination with gaming action upon the portable gaming system 130. In addition the sound signals that are emitted through the speakers on board the mobile toy vehicle 110 can include data transmitted to the vehicle from the portable gaming system 130 over the communication interface as a result of user interaction with the manual user interface upon the portable gaming system 130. In addition the sound signals that are emitted through the speakers on board the mobile toy vehicle 110 can include voice data from the user, the voice data captured by a microphone contained within or interfaced with the portable gaming system 130. In this way a user can project his or her voice from the portable gaming system 130 to the remote environment in which the mobile toy vehicle 110 is operating.

Light Generation in the Remote Toy Vehicle Space

The mobile toy vehicle 110 as described throughout this document can include additional means for interacting with the real environment around it such as having onboard lights that the mobile toy vehicle 110 can shine into its local environment under the control of the user as moderated by the intervening gaming software. The lights can include headlights, search lights, or colorful lights for simulating weapons fire, weapon hits, or incurred damage. The activation of the lights upon the mobile toy vehicle 110 are controlled in response to signals received from the portable gaming system 130, the signals sent at appropriate times in coordination with the gaming action upon the portable gaming system 130.

Robotic Effectors

The mobile toy vehicle 110 as described throughout this document can include additional means for interacting with the real environment around it such as having mobile effectors such as robotic arms or grippers or electromagnets that can be manipulated under electronic control and in accordance with control signals 150 received from the portable gaming system 130.

The activation of the effectors upon the mobile toy vehicle 110 are controlled in response to signals received from the portable gaming system 130, the signals sent at appropriate times in coordination with the gaming action upon the portable gaming system 130. In this way a user can pick up, push, or otherwise manipulate real objects within the real local space of the mobile toy vehicle 110, the picking up, pushing, or manipulation being selectively performed in coordination with other simulated gaming actions upon the portable gaming system 130.

Collisions with Real-World Objects and Simulation Interaction

As disclosed previously, some embodiments of the current invention include collision sensors aboard the mobile toy vehicle 110 such as contact sensors, pressure sensors, or force sensors within the bumpers of the vehicle or acceleration sensors within the body of the mobile toy vehicle 110.

Using any one or multiple the sensors, collisions between the mobile toy vehicle 110 and real physical objects can be detected and information relating to the collisions are transmitted back to the portable gaming system 130 over the communication interface. The information about the collisions are then used by the gaming software-running upon the portable gaming system 130 to update simulated gaming action. For example, sound effects can be generated by the portable gaming system 130 in response to detected real-world collisions. The sound effects can be displayed through speakers upon or local to the portable gaming system 130. The sound effects can also be displayed through speakers upon the mobile toy vehicle 110 (as described in the paragraph above). The sound effects can be dependent upon the direction or magnitude of the collision as detected through the sensors. The sound effects can also be dependent upon the speed or direction of motion of the mobile toy vehicle 110 at the time the collision is detected. The sound effects can also be dependent upon the then current gaming action displayed upon the portable gaming system 130 at the time the collision is detected.

Also, simulated sound effects, simulated damage levels can be adjusted within the simulation software running upon the portable gaming system 130 in response to real-world collisions detected upon mobile toy vehicle 110, the magnitude of the change in the simulated damage levels being optionally dependent upon the magnitude or direction of the collision as detected by sensors aboard the mobile toy vehicle 110. The magnitude of the change in the simulated damage level may be optionally dependent upon the speed or direction of motion of the mobile toy vehicle 110 at the time the collision is detected. Also the magnitude of the change in the simulated damage level may be optionally dependent upon the then current gaming action displayed upon the portable gaming system 130 at the time the collision is detected. In addition to, or instead of simulated damage levels, game scores can be adjusted within the gaming software running upon the portable gaming system 130 in response to real-world collisions detected upon the mobile toy vehicle 110, the magnitude of the change in score being optionally dependent upon the magnitude or direction of the collision as detected by sensors aboard the mobile toy vehicle 110. Also the magnitude of the change in the score may be optionally dependent upon the speed or direction of motion of the mobile toy vehicle 110 at the time the collision is detected. Also the magnitude of the change in score may be optionally dependent upon the then current gaming action displayed upon the portable gaming system 130 at the time the collision is detected. In addition to, or instead of game score changes, simulated game action can be modified within the gaming software running upon the portable gaming system 130 in response to real-world collisions detected upon the mobile toy vehicle 110, the type of the modified game action being optionally dependent upon the magnitude or direction of the collision as detected by sensors aboard the mobile toy vehicle 110. Also the type of the modified game action may be optionally dependent upon the speed or direction of motion of the mobile toy vehicle 110 at the time the collision is detected.

Also the type of the modified game action may be optionally dependent upon the then current gaming action displayed upon the portable gaming system 130 at the time the collision is detected. For example, the simulated game action can display a hidden treasure to a user if the mobile toy vehicle 110 collides with a wall or other real-world surface in a correct direction and at a speed that exceeds a particular threshold. As another example, the simulated game action can collect a piece treasure, causing it to disappear and incrementing the player's score, if the mobile toy vehicle 110 collides with a wall or other real-world surface in a correct location or correct direction or at a speed that exceeds a particular threshold. In this way simulated gaming action is moderated or updated based upon real-world interactions between the mobile toy vehicle 110 and the real physical space in which it operates.

Gaming Scores:

Another novel aspect of the present invention is that computer generated gaming score or scores, as computed by the gaming software running upon the portable gaming system 130, are dependent upon the simulated gaming action running upon the portable gaming system 130 as well as real-world motion of and real-world feedback from the mobile toy vehicle 110.

As described previously, scoring can be computed based upon the imagery collected from a camera or cameras aboard the mobile toy vehicle 110 or sensor readings from other sensors aboard the mobile toy vehicle 110 or the motion of the mobile toy vehicle 110, combined with simulated gaming action that occurs at the same time as the imagery is collected, the sensor readings are taken, or the motion of the mobile toy vehicle 110 is imparted.

For example, as described previously, scoring can be incremented, decremented, or otherwise modified based upon the robotic toy vehicle contacting or otherwise colliding with a real world physical object, the scoring also dependent upon the contacting or colliding occurring in coordination with simulated gaming action such as in coordination with a displayed image of a graphical target, treasure, barrier, obstacle, or weapon. As another example, as described previously, scoring can be incremented, decremented, or otherwise modified based upon the robotic toy vehicle targeting and firing a simulated weapon upon (and hitting) another real vehicle, simulated vehicle, or some other real or simulated object or target that appears upon the portable gaming system 130 display. As another example, as described previously, scoring can be incremented, decremented, or otherwise modified based upon the robotic toy vehicle being targeted and fired upon (and hit) by simulated weapons fire from another real vehicle controlled by another player through another portable gaming system 130 or by a simulated vehicle or other simulated opponent generated within the simulation run upon the portable gaming system 130.

In addition to the methods described in the paragraph above, other factors can be used to increment or decrement scoring variables upon the portable gaming system 130. For example a clock or timer upon the portable gaming system 130 can be used to determine how much time elapsed during a period in which the mobile toy vehicle 110 was required to perform a certain task or achieve a certain objective. The elapsed time, as monitored by software running upon the portable gaming system 130, adds to the challenge of the gaming experience and provides additional metrics by which to determine gaming performance of a user.

The User and Mobile Toy Vehicle Interaction

A particular advantage provided by the use of a portable gaming system 130 is that a user can walk around, following his or her mobile toy vehicle 110 as it traverses a particular local space. This could involve the user walking from room to room as his or her vehicle moves about his or her house. This could involve a user walking around a park, school yard, field, or other outside environment as his or her robotic toy vehicle traverses an outside space. The user can employ both direct visual sighting of his or her mobile toy vehicle 110 as well as first person video feedback collected from his or her mobile toy vehicle 110 (as displayed upon the screen of the portable gaming system 130) when engaging in the unique on-screen off-screen gaming experience.

When multiple users are engaged in a joint gaming experience that includes multiple portable gaming system 130 and multiple mobile toy vehicle 110, the multiple users can walk around in the same shared physical space while at the same time being privy only to the displayed feedback from their own portable gaming system 130. In this way the users can experience both shared and private aspects of the joint gaming experience. For example an second player may not know how much simulated fuel a first player has left, and vice versa, for each of their fuel displays are only provided upon each of their respective portable gaming system 130.

In some embodiments a non-portable gaming system 130 can be used alone or in combination with portable gaming system 130, the non-portable gaming system 130 acting as stationary gaming station for mobile toy vehicle 110 control or a central sever for coordinating the portable gaming system 130.

User Gaming Scenario

The unique methods and apparatus disclosed herein enable a wide variety of gaming scenarios that merge simulated gaming action with real world motion and feedback from robotic toy vehicles. The gaming scenarios can be single player or multi player.

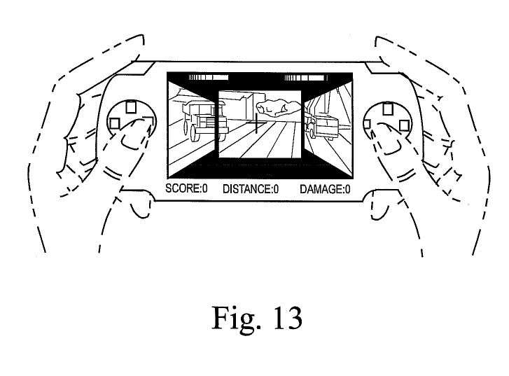

As one simple example of such gaming action, a game scenario is enabled upon a portable gaming system 130 by software running upon the portable gaming system 130 that functions as follows: two users compete head to head in a task to gather the most simulated treasure (cubes of gold) while battling each other for dominance using the simulated weapons aboard their vehicles. Each user has a portable gaming system 130 connected by wireless communication link to a mobile toy vehicle 110. The two portable gaming system 130 are also in communication with each other by wireless communication links. In this case, all wireless communication links use Bluetooth technology. The game begins by each user placing their vehicles in different rooms of a house and selecting the “start game” option on the user interface of their portable gaming system 130. An image appears upon each player's portable gaming system 130, the image a composite of the video feedback from the camera mounted upon the mobile toy vehicle 110 being controlled by that user combined with overlaid graphical imagery of a vehicle cockpit (including windows and dashboard meters and readouts). The overlaid graphical imagery includes a score for each user, currently set to zero. The overlaid graphical imagery also includes a distance traveled value for each user and is currently set to zero. The overlaid graphical imagery also includes a damage value for each user and is currently set to zero. The overlaid graphical imagery also includes a fuel level value and an ammunition level value, both presented as graphical bar meters shown in FIG. 13. [NOTE, FIG. 13 is not as it should be in my printout]. The full fuel level is represented by the red bar along the top of the display and the full ammunition level is represented by the green bar along the top of the display. The fuel level bar and ammunition level bar are displayed at varying lengths during the game as the simulated fuel and simulated ammunition are used, the length of the displayed red and green bars decreasing proportionally to simulated fuel usage and simulated ammunition usage respectively. When there is no fuel left in the simulated tank, the red bar will disappear from the display. When there is no ammunition left in the simulated weapon the green bar will disappear from the display. Also drawn upon the screen is a green crosshair in the center of the screen. This crosshair represents the current targeting location of the simulated weapons of the simulated vehicle that is being controlled this displayed portable gaming system 130, the targeting location being shown relative to the real physical environment of the mobile toy vehicle 110. In this way simulated vehicle information, including simulated targeting information, are merged with the real physical space of the mobile toy vehicle 110 creating a merged on-screen off-screen gaming scenario.

Once the game has been started by both users, they press buttons upon their portable gaming system 130 to move their mobile toy vehicle 110 about the real physical space of their house. As they move the vehicles the camera feedback is updated, giving each player a real-time first-person view of the local space as seen from the perspective of their mobile toy vehicle 110. They are now playing the game—their gaming goal as moderated by the gaming software running on each portable gaming system 130 for each player to move his or her mobile toy vehicle 110 about the real physical space of the house, searching for simulated targets that will be overlaid onto the video feedback from their vehicle camera by the software running on their portable gaming system 130. If and when they encounter their opponent (the mobile toy vehicle 110 controlled by the other player) they must either avoid that vehicle or engage it in battle, damaging that vehicle before it damages them. In this particular gaming embodiment, the simulated targets are treasure (cubes of gold) to be collected by running their vehicle into the location of the treasure.

The software running upon each portable gaming system 130 decides when and where to display such treasure based upon the accrued distance traveled by each mobile toy vehicle 110 (as determined by optical encoders measuring the accrued rotation and orientation of the wheels of the vehicle). As the gold cubes are found and collided with, the score of that user is increased and displayed upon the portable gaming system 130. Also displayed throughout the game are other targets including additional fuel and additional ammunition, also acquired by driving the real vehicle into the location that appears to collide with the simulated image of the fuel or ammo. When simulated fuel or simulated ammo are found and collided with by a vehicle, the simulated fuel levels or simulated ammo levels are updated for that vehicle in the simulation software accordingly. The game ends when the time runs out (in this embodiment when 10 minutes of playing time has elapsed) as determined using a clock or timer within one or both portable gaming system 130 or when one of the vehicles destroys the other of the vehicles in battle. The player with the highest score at the end of the game is the winner.

Advanced Tracking

In an advanced embodiment of the present invention, an absolute spatial position or orientation sensor 218 is included upon both the portable gaming system 130 and the mobile toy vehicle 110 such that the software running upon the portable gaming system 130 can compute the relative location or orientation between the player (who is holding the portable gaming system 130) and the robotic toy vehicle he is controlling.

In one embodiment the absolute spatial position sensor is a GPS sensor. A first GPS sensor is incorporated within or connected to the portable gaming system 130. For example if the portable gaming system 130 is a Sony PlayStation Portable, a commercially available GPS sensor (and optional magnetometer) can be plugged into a port of the device and is thereby affixed locally to the device. A second GPS sensor (and optional magnetometer) is incorporated within or connected to the mobile toy vehicle 110. Spatial position and/or motion and/or orientation data derived from the GPS sensor (and optional magnetometer) is transmitted back to the portable gaming system 130 over the bi-directional communication link. In this way the portable gaming system 130 software has two sets of locative data (i.e. positions and optional orientations). A first set of locative data that indicates the spatial position and/or motion and/or orientation of the portable gaming system 130 itself and a second set of locative data that indicates the spatial position and/or motion and/or orientation of the mobile toy vehicle 110. The portable gaming system 130 can then use these two sets of data and compute the difference between them thereby generating the relative distance between the portable gaming system 130 and the mobile toy vehicle 110, the relative orientation between the portable gaming system 130 and the mobile toy vehicle 110, the relative speed between the portable gaming system 130 and the mobile toy vehicle 110, or the relative direction of motion between the portable gaming system 130 and the mobile toy vehicle 110.

Such difference information can then be used to update gaming action. Such difference information can also be displayed to the user in numerical or graphical form. For example the relative distance between the portable gaming system 130 and the mobile toy vehicle 110 can be displayed as a numerical distance (in feet or meters) upon the display of the portable gaming system 130. In addition an arrow can be displayed upon the screen of the portable gaming system 130, the arrow pointing in the direction from the portable gaming system 130 to the mobile toy vehicle 110. In addition a different colored arrow can be displayed upon the screen of the portable gaming system 130 indicating the direction of motion (relative to the portable gaming system 130) that the mobile toy vehicle 110 is then currently moving. Using such display information, as derived from the plurality of spatial position or orientation sensors 218, the player of the gaming system can keep track of the relative position or orientation or motion of the mobile toy vehicle 110 during gaming action.

For embodiments of the current invention that include a plurality of mobile toy vehicle 110, each of the mobile toy vehicle 110 equipped with a spatial position sensor such as a GPS sensor and an optional magnetometer, additional advanced features can be enabled.

For example, in some embodiments the locative sensor data from the plurality of mobile toy vehicle 110 are sent to a particular one (or more) of the portable gaming system 130. In other words, a portable gaming system 130 being used by a first player will received locative data from a first mobile toy vehicle 110 over the bi-directional communication link, that mobile toy vehicle 110 being the one the first player is controlling.

In addition, the portable gaming system 130 being used by the first player will also receive locative data from a second mobile toy vehicle 110 over a bi-directional communication link, that mobile toy vehicle 110 being one that a second player is controlling. Also, the portable gaming system 130 being used by the first player will ALSO receive locative data from a third mobile toy vehicle 110 over a bi-directional communication link, that mobile toy vehicle 110 being one that a third player is controlling. Using the data from the first, second, and third locative sensors aboard the first, second, and third mobile toy vehicle 110, the gaming software upon the first portable gaming system 130 can update the gaming action as displayed upon the screen of that gaming system. For example, the gaming software upon the first portable gaming system 130 computes and displays the relative distance, or orientation, or motion between the first mobile toy vehicle 110 and the second mobile toy vehicle 110. This may be displayed, for example, as simulated radar upon the display of the first portable gaming system 130, again mixing real-world gaming action with simulated gaming action.

The gaming software upon the first portable gaming system 130 also computes and displays the relative distance, or orientation, or motion between the first mobile toy vehicle 110 and the third mobile toy vehicle 110. In this way the first player can be displayed information upon his portable gaming system 130 that indicates the relative position or motion or orientation between the mobile toy vehicle 110 that he is controlling (the first vehicle) and the mobile toy vehicle 110 another player is controlling (the second vehicle). In addition the first player can be displayed information upon his portable gaming system 130 that indicates the relative position or motion or orientation between the mobile toy vehicle 110 that he is controlling (the first vehicle) and the mobile toy vehicle 110 a third player is controlling (the third vehicle). And if additional mobile toy vehicle 110 were being used, each with additional position sensors, the displayed information could include relative position or motion or orientation between the first vehicle and each of the additional vehicles as well. In this way the first player can know the position, motion, or orientation of one or more of the other mobile toy vehicle 110 that are participating in the game. In some cases those other mobile toy vehicle 110 are opponents in the gaming scenario. In other cases those other mobile toy vehicle 110 are teammates in the gaming scenario. In some embodiments the position, motion, or orientation of only certain mobile toy vehicle 110 are displayed—for example only of those mobile toy vehicle 110 that are teammates in the gaming scenario.

In other embodiments the position, motion, or orientation of only other certain mobile toy vehicle 110 are displayed—for example only those mobile toy vehicle 110 that are within a certain range of the portable gaming system 130 of the first player, or only the mobile toy vehicle 110 that are within a certain range of the first mobile toy vehicle 110, or only the mobile toy vehicle 110 that are opponents of the first player, or only the mobile toy vehicle 110 that do not then currently have a simulated cloaking feature enabled, or only the mobile toy vehicle 110 that do not have a simulated radar-jamming feature enabled, or only the mobile toy vehicle 110 that do not have a shield feature enabled, or only the mobile toy vehicle 110 that are not obscured by a simulated terrain feature such as a mountain, hill, or barrier.

The embodiment above including a plurality of mobile toy vehicle 110, each with a spatial position sensor aboard, the user of the first portable gaming system 130 can be displayed either the position, motion, or orientation of the plurality of mobile toy vehicle 110 relative to the first portable gaming system 130 or can be displayed the position, motion, or orientation of the plurality of mobile toy vehicle 110 relative to the first mobile toy vehicle 110. The display can be numerical, for example indicating a distance between each of the mobile toy vehicle 110 and the first portable gaming system 130 or indicating a distance between each of the mobile toy vehicle 110 and the first mobile toy vehicle 110. The display can also be graphical, for example plotting a graphical icon such as dot or a circle upon a displayed radar map, the displayed radar map representing the relative location of each of the plurality of mobile toy vehicle 110. The color of the dot or circle can be varied to allow the user to distinguish between the plurality of mobile toy vehicle 110. For example in one embodiment all teammate vehicles are be displayed in one color and all opponent vehicles are displayed in another color, and the vehicle that is being controlled by the player who is wielding that particular portable gaming system 130 is displayed brighter than all other others. In this way that player can know the location of his or her own vehicle, the locations of his or her teammate vehicles, and the location of his or her opponent vehicles. Also if there are entirely simulated vehicles operating along the mobile toy vehicle 110 in the current gaming scenario the locations of the simulated vehicles can optionally be displayed as well. In some embodiments the simulated vehicles are displayed in a visually distinct manner such that they can be distinguished from real vehicles, for example being displayed in a different color, different shape, or different brightness.

It should be noted that the description above focused upon the display of the first player upon the first portable gaming system 130, it should be understood that a similar display can be created upon the portable gaming system 130 of the other users, each of their displays being generated relative to their portable gaming system 130 or relative to their mobile toy vehicle 110. In this way all player (or a selective subset of users) can be provided with spatial information about other users with respect to their own location or the location of the mobile toy vehicle 110 that they are personally controlling.

User to User Sensor Data Interaction

For embodiments such as the ones described above in which a single portable gaming system 130 receives data (such as GPS data and magnetometer data) from a plurality of different mobile toy vehicle 110 over bi-directional communication links, a unique ID can be associated with each stream or packet of data such that the single portable gaming system 130 can determine from which mobile toy vehicle 110 the received data came from or is associated with. It should also be noted that in some embodiments the from a plurality of the different mobile toy vehicle 110 is not communicated directly to the first portable gaming system 130 but instead is communicated via other of the portable gaming system 130.

In such an embodiment each mobile toy vehicle 110 may be configured to communicate ONLY with a single one of the portable gaming system 130, the sensor data from the plurality of mobile toy vehicle 110 being exchanged among the portable gaming system 130 to enable the features described above. In this way a portable gaming system 130 can selectively send data about the location of its mobile toy vehicle 110 to other of the portable gaming system 130, the selective sending of the data depending upon the simulated gaming action as controlled by software running upon the portable gaming system 130.

For example, if a particular mobile toy vehicle 110 has a simulated cloaking feature or a simulated radar jamming feature enabled at a particular time, the portable gaming system 130 that is controlling that mobile toy vehicle 110 can, based upon such current gaming action, selectively determine not to send location information about the mobile toy vehicle 110 to some or all of the other portable gaming system 130 currently engaged in the game. Similarly, if a particular mobile toy vehicle 110 is hidden behind a simulated mountain or barrier, the portable gaming system 130 that is controlling that mobile toy vehicle 110 can, based upon such current gaming action, selectively determine not to send location information about the mobile toy vehicle 110 to some or all of the other portable gaming system 130 currently engaged in the game.

Alternate Mobile Vehicle Tracking Methods

The features described above that use relative or absolute position, motion, or orientation of vehicles or gaming systems are described with respect to GPS sensors other sensors or other sensing methods can be used. For example, optical encoders can be used aboard the mobile toy vehicle 110 to track the rotation of wheels as well as the steering angle. By tracking the rotation of wheels and the steering direction during the rotations of the wheels, the relative position, motion, or orientation of a vehicle can be tracked over time. This method has the advantage of being cheaper than GPS and works better indoors than GPS, but is susceptible to errors if the wheels of a vehicle slip with respect to the ground surface and thereby distort the accrued distance traveled or direction traveled information.

An alternative sensing method that is inexpensive and accurate on indoor floor surfaces is hereby disclosed herein as a novel method of tracking the location, motion, or orientation of a mobile toy vehicle 110 with respect to a ground surface. This sensing method uses one or more optical position sensors on the undersurface of the mobile toy vehicle 110 and aimed down at the floor. Such sensors, as commonly used in optical computer mice, illuminate a small surface area with an LED and takes optical pictures of that surface at a rapid rate (such as 1500 pictures per second) using a silicon optical array called a Navigation Chip. Integrated electronics then determine the relative motion of the surface with respect to the sensor. As described in the paper “Silicon Optical Navigation” by Gary Gordon, John Corcoran, Jason Hartlove, and Travis Blalock of Agilent Technology (the maker of the Navigation Chip), the paper hereby incorporated by reference, this sensing method is fast, accurate, and inexpensive. For these reasons such sensors are hereby proposed in the novel application of tracking the changing position or orientation of a mobile toy vehicle 110. To get accurate orientation sensing, two of the Navigation Chip sensors can be used upon the undersurface of the vehicle with a disposed distance between them. By comparing the differing position change data from each of the two sensors, the changing rotation of the vehicle can be derived in software.

Another novel method for tracking the position or orientation changes of the mobile toy vehicle 110 is hereby disclosed, the method also using the Navigation Chip technology from Agilent. In this embodiment the Navigation Chip is not mounted on the undersurface of the mobile toy vehicle 110 and aimed at the floor as described in the example above, but instead is aimed outward toward the room within which the mobile toy vehicle 110 is manipulating. This chip takes rapid low resolution snapshots of the room the way a camera would and uses integrated electronics to compute the relative motion (offset) of the snapshots. Because it is assumed that the room itself is stationary and the mobile toy vehicle 110 is that which is moving, the motion between snapshots (i.e. the offset) can be used to determine the relative motion of the vehicle over time (changing position or orientation). Multiple of the Navigation Chips can be used in combination to get more accurate change information. For example two sensors—one sensor pointed along the forward motion of the vehicle and one sensor pointed to the left (at a right angle to the forward sensor). Or as another example four sensors—one sensor pointed in each of four directions—forward, back, left, and right.

Another method for tracking the position or orientation changes of the mobile toy vehicle 110 is to use the camera mounted on the vehicle (as discussed throughout this disclosure) and compare subsequent camera images to determine motion of the vehicle from image offset data. The technique is similar to that used by the Agilent sensor described above. The advantage of using the camera instead of the Agilent sensor is that the more accurate visual data yields greater resolution in position and orientation change information. The disadvantage of using the camera is the need for more expensive processing electronics to get a rapid update rate. A rapid update rate is critical for accurate position or orientation change data for a mobile toy vehicle 110 that is moving or turning quickly over time.

Storing and Displaying Trajectory Information

Another feature enabled by the methods and apparatus disclosed herein is the storing and displaying of trajectory information. Position or orientation or motion data related to a mobile toy vehicle 110 is captured and transmitted to a portable gaming system 130 as disclosed previously. This data is then stored in memory local to the portable gaming system 130 along with time information indicating the absolute or relative time when the position or orientation or motion data was captured. This yields a stored time-history of the mobile toy vehicle 110 position or orientation or motion within the memory of the portable gaming system 130. The time history is used to update gaming action.

In some embodiments the user can request to view a graphical display of the time history, the graphical display for example being a plot of the position the mobile toy vehicle 110 during a period of time. If for example the user had commanded the mobile toy vehicle 110 to traverse a large oval trajectory, an oval shape is plotted upon the portable gaming system 130.

In other embodiments the scoring of the game is based in whole or in part upon the stored time-history of the mobile toy vehicle 110 position or orientation or motion. For example the game might require a player to command his or her mobile toy vehicle 110 to perform a “figure eight”. The software running upon the portable gaming system 130 can score the user's ability to perform the “figure eight” by processing the time-history data and comparing the data with the characteristic figure eight shape. In this way a user's ability to command a robot to perform certain trajectories can be scored as part of the gaming action.

In other embodiments, the engagement of simulated elements within the gaming action is dependent upon the time history data. For example, certain simulated treasures within a gaming scenario might only be accessible when reaching that treasure from a certain direction (for example, when coming upon the treasure from the north). To determine how the robotic vehicle comes upon a certain location, as opposed to just determining if the vehicle is at that certain location, the software running upon the portable gaming system 130 can use the time-history of data.

Mobile Toy Vehicle Communication Channel

A bidirectional communication channel is established between the portable gaming system 130 and the mobile toy vehicle 110, the communication connection for transmitting control signals 150 from the portable gaming system 130 to the mobile toy vehicle 110 and for transmitting sensor data from the from the mobile toy vehicle 110 to the portable gaming system 130.

In some embodiments the mobile toy vehicle 110 can transmit the sensor data to a plurality of portable gaming system 130 devices, each of the portable gaming system 130 devices updating software controlled gaming action in response to the data.

In some embodiments a single portable gaming system 130 can selectively transmit control signals 150 to a plurality of mobile toy vehicle 110, each of the mobile toy vehicle 110 identifiable by a unique ID.

In some embodiments a single portable gaming system 130 can receive sensor data from a plurality of mobile toy vehicle 110, the sensor data from each of the mobile toy vehicle 110 being associated with a unique ID for that vehicle.

In some embodiments a portable gaming system 130 can communicate with a plurality of other portable gaming system 130, each of the portable gaming system 130 identifiable by a unique ID, the portable gaming system 130 exchanging data related to the real or simulated status of a plurality of vehicles being controlled by a plurality of users. In some embodiments the bidirectional communication channel is established using a digital wireless communication means such as a Bluetooth communication connection. In such digital embodiments the control signals 150 sent from the portable gaming system 130 to the mobile toy vehicle 110 are digital commands.

In some embodiments the digital commands follow a command protocol of a variety of commands, each of the commands including a command identifier and command data. For example a digital command identifier is sent from the portable gaming system 130 to the mobile toy vehicle 110 that indicates a “move forward” command and the command data includes a value representing the speed at which the mobile toy vehicle 110 is to move. Alternative command data can include the distance by which the mobile toy vehicle 110 is to move. Alternative command data can include the time for which the mobile toy vehicle 110 should move at a particular speed. Other command identifiers include a “turn left” command and a “turn right” command and a “headlights on” and “headlights off” command and a “move backward” command and a “sound effect” command and a “zoom camera” command and a “pan camera” command and a “fire weapon” command and a “report GPS data” command and a “report ultrasound sensor” command and a “report distance traveled” command and a “spin in place” command. Such commands may or may not include command data. If command data is used along with a particular command identifier, the command data may include but is not limited to magnitude values, direction values, duration values, distance values, or time delay values. In addition a command can include a device ID that indicates to which of multiple mobile toy vehicle 110 the command is intended for.

In general electronics within each of the mobile toy vehicle 110 interprets the received control signals 150 that are intended for it (as optionally identified by the device ID) and then controls sensors or actuators or lights or speakers or cameras accordingly.

During implementation, Bluetooth is a preferred wireless communication technology for transmitting control signals 150 from portable gaming system 130 to mobile toy vehicle 110, for transmitting sensor data sent from mobile toy vehicle 110 to portable gaming system 130, and for exchanging game-related data between and among portable gaming system 130 consistent with the features and functions of this invention. Other communication technologies can be used, digital or analog. For example other digital wireless communication methodologies can be used such as WiFi and WLAN. Also, purely analog communication methods can be used in some embodiments for certain appropriate features, for example analog radio frequency communication can be used to convey camera images from the mobile toy vehicle 110 to the portable gaming system 130 or to convey motor power levels from the portable gaming system 130 to the mobile toy vehicle 110.

Camera Zoom Control

Another feature enabled in some embodiments of the current invention is a zoom control that adjusts the camera lens zoom focusing upon the mobile toy vehicle 110.

This is achieved by sending control signals 150 related to camera lens zoom focusing from the portable gaming system 130 to the mobile toy vehicle 110 in response to user interactions with buttons (or other manual controls) upon the portable gaming system 130. For example a zoom lever is incorporated upon one embodiment of the portable gaming system 130 such that when a user pushes the zoom lever forward, control signals 150 are sent from the portable gaming system 130 to the mobile toy vehicle 110 to cause the camera to zoom in. Alternatively when the user pushes the zoom lever backwards, control signals 150 are sent from the portable gaming system 130 to the mobile toy vehicle 110 to cause the camera to zoom out.

Electronics upon the mobile toy vehicle 110 receives and interprets the control signals 150 from the portable gaming system 130 and controls actuators that adjust the camera zoom appropriately.

Physical Space Targeting and Overlaid Graphics

One of the valuable features enabled by the methods and apparatus disclosed herein is the ability for a player of a computer game to target real physical locations or real physical objects or other real robotic devices by adjusting the position, orientation, or focus of a robotically controlled video camera within a real physical space such that an overlaid graphical image such as a graphical crosshair is positioned upon the video image of the location, object, or real robotic device. In one embodiment the method functions as follows—a video image of a remote physical space is received from a remote camera mounted upon the mobile toy vehicle 110, the direction and orientation of the camera dependent upon the direction and orientation of the mobile toy vehicle 110 with respect real physical space as well as the direction and orientation of the camera with respect to the mobile toy vehicle 110. The video image from the remote camera is displayed upon the screen of the portable gaming system 130 for a user to view. A graphical image of a crosshair is drawn overlaid upon the video image, the graphical image of the crosshair being drawn at a fixed location upon the screen of the portable gaming system 130, for example at or near the center of the screen, as shown in FIG. 8 and FIG. 13 herein. The user presses buttons (or engages other manual controls) upon the portable gaming system 130, the particular buttons or other controls associated with a desired physical motion of the mobile toy vehicle 110. In response to the user button presses (or other manual control manipulations), the portable gaming system 130 sends control signals 150 to the mobile toy vehicle 110 causing the mobile toy vehicle 110 to move in position or orientation with respect to the real physical space by energizing appropriate motors within the vehicle. Meanwhile updated video images continue to be received by the portable gaming system 130 from the camera upon the mobile toy vehicle 110, the images displayed upon the screen of the portable gaming system 130. Also the graphical image of the crosshairs continue to be drawn overlaid upon the updated video image, the location of the crosshairs being drawn at the fixed location upon the screen of the portable gaming system 130. Because the crosshairs are displayed at a fixed location upon the screen while the video image is changing based upon the motion of the mobile toy vehicle 110, the player is given the sense that the crosshairs are moving about the real physical space (even though the crosshairs are really being displayed at a fixed location upon the screen of the portable gaming system 130). In this way a user can position the crosshairs at different locations or upon different objects within the remote space, thereby performing gaming actions. For example, by moving the position or orientation of the mobile toy vehicle 110 as described herein, a player can position the crosshairs upon a particular object within the real physical space. Then by pressing another particular button (or by adjusting some other particular manual control) upon the portable gaming system 130, the user identifies that object, selects that object, fires upon that object, or otherwise engages that object within the simulated gaming action. In this way the mobile camera affixed to the mobile toy vehicle 110, by sending images with changing perspective to the portable gaming system 130, the images combined by gaming software with overlaid graphical crosshairs, the graphical crosshairs drawn at a fixed location while the video image is changing in perspective with respect to the real physical space, allows the player to target, select, or otherwise engage a variety of real physical locations or real physical objects or other real physical mobile toy vehicle 110 while playing a simulated gaming scenario. This creates a combined on-screen off-screen gaming experience in which a user can use a portable gaming system 130 to move a real physical toy about a real physical space while engaging software generated gaming actions relative to that real physical toy and that real physical space.

What is claimed is:

1. An apparatus for combined on-screen and off-screen user entertainment, said apparatus comprising:
a mobile toy vehicle that varies its position and orientation within the physical world in response to received control commands, the mobile toy vehicle including a drive system, an on-board camera, and a wireless communication link;
a portable gaming system running gaming software, the portable gaming system including a visual display, user input controls, and a wireless communication link; said portable gaming system operative to receive real-time camera data from said mobile toy vehicle over said communication link and display a representation of said camera data upon said visual display, said portable gaming system also operative and send control commands to said mobile toy vehicle over said communication link in response to user manipulation of said user input control; and
gaming software running upon said portable gaming system, said gaming software operative to monitor game play and provide the user with a simulated vehicle, the simulated vehicle combining the real-world functions and features of the mobile toy vehicle with simulated features and functions that are overlaid upon the visual display of the camera data and/or introduced into the control interface between the user and the mobile toy vehicle.

2. The apparatus as in claim 1; wherein the mobile toy vehicle further comprises:
a mock weapons system;
a software configurable vehicle computer control system;
wherein said software configurable vehicle computer control system operatively controls the drive system, the weapons system, the video camera, and the communications link.

3. The apparatus as in claim 1 wherein said drive system includes an electronically controlled motor that powers one or more wheels.

4. The apparatus as in claim 1 wherein the maximum speed of the drive system is limited by one or more simulated vehicle parameters maintained by the gaming software and effected by the status of game play.

5. An apparatus as in claim 4 wherein said one or more simulated vehicle parameters includes a simulated terrain parameter for the environment of the simulated vehicle.

6. The apparatus as in claim 1 wherein the mobile toy vehicle further comprises:
a vehicle location system;
wherein said vehicle location system is connected to a software configurable vehicle computer control system.

7. The apparatus as in claim 1 wherein the mobile toy vehicle further comprises:
a microphone;
wherein said microphone is connected to a software configurable vehicle computer control system.

8. The apparatus as in claim 1 wherein one or more display qualities of said camera data is modified in response to one or more simulated vehicle parameters maintained by the gaming software and effected by the status of game play.

9. The apparatus as in claim 8 wherein one of said one or more display qualities is a the brightness of the display of said camera data.

10. An apparatus as in claim 9 wherein said one or more simulated vehicle parameters includes a simulated time of day parameter for the environment of the simulated vehicle.

11. An apparatus as in claim 9 wherein said one or more simulated vehicle parameters includes a simulated weather parameter for the environment of the simulated vehicle.

12. An apparatus as in claim 8 wherein said one or more simulated vehicle parameters includes a status parameter for a simulated shield of the simulated vehicle.

13. The apparatus as in claim 1 wherein the mobile toy vehicle further comprises a light, wherein said light is connected to a software configurable vehicle computer control system.

14. The apparatus as in claim 13 wherein the signal amplitude of the light is modified by the vehicle computer control system in response to one or more parameters maintained by the gaming software and effected by the status of game play.

15. The apparatus as in claim 6 wherein the vehicle location system includes one or more of a GPS sensor, a magnetometer, or an optical sensor.

16. The apparatus as in claim 1 wherein that the gaming software is further operative to:
maintains a list of physical object images; and
maintains a list of virtual objects, with the virtual objects being identified with the physical object images, and with the virtual objects being displayed as overlays upon said video image data.

17. The apparatus as in claim 1 wherein the gaming software is further operative to display upon said screen, a simulated ammunition level for the simulated vehicle.

18. The apparatus as in claim 1 wherein the gaming software is further operative to display upon said screen, a simulated fuel and/or power level for the simulated vehicle.

19. The apparatus as in claim 1 wherein the gaming software is further operative to display upon said screen, a simulated shield strength level for a simulated shield of the simulated vehicle, the simulated shield being operative to reduce the simulated damage imparted upon the simulated vehicle by certain

23. The method according to claim/wherein the mobile toy vehicle stops when hitting a simulated barrier.

24. The method according to claim 22 wherein the user's ability to control the mobile toy vehicle drive system and/or steering system is modified by a simulated terrain feature maintained by said portable gaming system

25. The method according to claim 22 wherein the user's ability to control the mobile toy vehicle drive system and/or vehicle steering system is modified by a simulated fuel level and/or damage level maintained by said portable gaming system.

26. The method according to claim 22. wherein the portable gaming system emits a sound when said mobile toy vehicle has a real-world collision.

27. The method according to claim 22. wherein the mobile toy vehicle emits a sound based upon simulated gaming action determined by said portable gaming system.

28. The method according to claim 22 wherein the portable gaming system maintains and displays a score upon said screen, said score being based at least in part upon real-world actions of said mobile toy vehicle.

29. The method according to claim 22 wherein the score is modified based at least in part upon a measured time.

30. The method according to claim 22 wherein said portable gaming system is operative to display overlaid crosshairs upon said real-time camera image, said crosshairs showing the location within the real physical world at which a simulated weapon of said mobile toy vehicle is aimed.

31. The method according to claim 22 wherein the relative location of the mobile toy vehicle to the user of the portable gaming system is computed by:
reading the location sensor on the portable gaming system;
reading the location sensor on the mobile toy vehicle;
computing the difference between the two values.

32. The method according to claim 31 wherein the relative location is graphically displayed on the screen.

33. The method according to claim 22 further comprising: recording the orientation and position of the mobile toy vehicle on a periodic basis.

34. The method according to claim 22 wherein the screen displays a crosshairs over said real-time camera image, and the user identifies a real-world object using the crosshairs with manual interaction.

35. A method for an on-screen/off-screen gaming experience, said method comprising:
Enabling a first user to control the position and orientation of a first mobile toy vehicle by manipulating manual input controls upon a first portable gaming system, said first portable gaming system communicating with said first mobile toy vehicle over a first wireless communication link.
Enabling a second user to control the position and orientation of a second mobile toy vehicle by manipulating the manual input control upon a second portable gaming system, said second portable gaming system communicating with said second mobile toy vehicle over a second wireless communication link.
Enabling said first portable gaming system to exchange gaming information with said second portable gaming system over a third wireless communication link.

36. A method as recited in claim 35 wherein said first portable gaming system runs gaming software, said gaming software operative to moderate a simulated gaming experience that is updated at least in part based upon manual input provided by said first user through said manual input control of said first portable gaming system and upon gaming information received from said second portable gaming system over said third wireless communication link.

37. A method as recited in claim 36 wherein said second portable gaming system also runs gaming software, said gaming software operative to moderate a simulated gaming experience that is updated at least in part based upon manual input provided by said second user through said manual input control of said second portable gaming system and upon gaming information received from said first portable gaming system over said third wireless communication link.

38. A method as recited in claim 36 wherein said first user's ability to control the position of said first vehicle using the manual input control of said first portable gaming system is dependent at least in part upon one or more simulation parameters updated within said gaming software.

39. A method as recited in claim 38 wherein said one or more simulation parameters includes a simulated damage parameter.

40. A method as recited in claim 38 wherein said one or more simulation parameters includes a simulated terrain parameter.

41. A method as recited in claim 38 wherein said one or more simulation parameters includes a fuel level and/or power level parameter.

42. A method as recited in claim 35 wherein said first mobile toy vehicle includes a first camera mounted upon it and operative to capture image data, said image data transmitted to said first portable gaming system over a wireless communication link and displayed upon a display screen of said first portable gaming system.

43. A method as recited in claim 42 wherein said second mobile toy vehicle includes a second camera mounted upon it and operative to capture image data, said image data transmitted to said second portable gaming system over a wireless communication link and displayed upon a display screen of said second portable gaming system.

44. A method as recited in claim 35 wherein said first portable gaming system displays a score to said first user, said score based at least in part upon said gaming information received form said second portable gaming system over said third communication link.

45. A method as recited in claim 35 wherein said first portable gaming system displays status information related to said second mobile toy vehicle, said status information based at least in part upon said gaming information received from said second portable gaming system over said third communication link.
